(19) United States
(12) Patent Application Publication
(10) Pub. No.: US 2026/0333036 A1
(43) Pub. Date: Oct. 22, 2026

(54) NON-ACCESS STRATUM FOR AMBIENT INTERNET OF THINGS DEVICES

(71) Applicant: Lenovo (United States) Inc., Morrisville, NC (US)

(72) Inventors: Thomas Ralph Luetzenkirchen, Berlin (DE); Andreas Kunz, Ladenburg (DE); Genadi Velev, Darmstadt (DE); Hyung-Nam Choi, Ottobrunn (DE)

(73) Assignee: Lenovo (United States) Inc., Morrisville, NC (US)

(21) Appl. No.: 19/285,923

(22) Filed: Jul. 30, 2025

(51) Int. Cl. H04W 12/06

(52) U.S. Cl. CPC H04W 12/06

(57) ABSTRACT

Various aspects of the present disclosure relate to non-access stratum (NAS) for ambient Internet of Things (AIoT) devices. An AIoT device may communicate with an AIoT function (AIoTF) implemented by a network entity (NE). The AIoT device may, for example, receive a first AIoT NAS message that includes a security header type, a message type, and a message authentication code. The first AIoT NAS message may be a command request message (e.g., a read command message, a write command message, a disable command message), based on which the AIoT device initiates a corresponding operation. The AIoT device may transmit, to the AIoTF and in response to the first AIoT NAS message, a second AIoT NAS message that includes the security header type, a message type, and a message authentication code. The second AIoT NAS message may indicate a result of the corresponding operation.

### TECHNICAL FIELD

The present disclosure relates to wireless communications, and more specifically to a lightweight and simplified non-access stratum (NAS) protocol for ambient Internet of Things (AIoT) devices.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., implementing an AIoT function (AIoTF), NE, UE), processors, and methods of the present disclosure each have several innovative aspects, no single one of which is solely responsible for the desirable features disclosed herein.

A device (e.g., a UE or AIoT device) for wireless communication is described. The UE may be configured to, capable of, or operable to perform one or more operations as described herein. For example, the device may be configured to, capable of, or operable to receive a first AIoT NAS message that includes a security header type, a message authentication code, and a message type, and transmit, in response to the first AIoT NAS message, a second AIoT NAS message that includes the security header type, the message authentication code, and the message type indication.

A processor (e.g., a standalone processor chipset, or a component of a UE or of an AIoT device) for wireless communication is described. The processor may be configured to, capable of, or operable to perform one or more operations as described herein. For example, the processor may be configured to, capable of, or operable to receive a first AIoT NAS message that includes a security header type, a message authentication code, and a message type, and transmit, in response to the first AIoT NAS message, a second AIoT NAS message that includes the security header type, the message authentication code, and the message type indication.

A method performed or performable by an apparatus (e.g., a UE or AIoT device) for wireless communication is described. The method may include receiving a first AIoT NAS message that includes a security header type, a message authentication code, and a message type, and transmitting, in response to the first AIoT NAS message, a second AIoT NAS message that includes the security header type, the message authentication code, and the message type indication.

In some implementations of the device, the processor, and the method described herein, the device, the first AIoT NAS message may be a read command NAS message that includes a memory pointer information element (IE) that indicates a start address within the at least one memory and a data size IE that indicates a first quantity of octets of data to be retrieved from the at least one memory.

In some implementations of the device, the processor, and the method described herein, the device, the processor, and the method may further be configured to, capable of, or operable to initiate, in response to the read command NAS message, a read operation to retrieve the data from the at least one memory according to the memory pointer IE and the data size IE.

In some implementations of the device, the processor, and the method described herein, the second AIoT NAS message may indicate a failure cause based on a failure result of the read operation.

In some implementations of the device, the processor, and the method described herein, the retrieved data may include a second quantity of octets that is less than the first quantity of octets indicated by the data size IE, and the second AIoT NAS message may be a read complete NAS message that includes an AIoT data IE with an AIoT data length equal to the second quantity of octets.

In some implementations of the device, the processor, and the method described herein, the device, the processor, and the method may further be configured to, capable of, or operable to receive a subsequent read command NAS message that indicates, based on the second quantity of octets, an updated memory pointer IE and an updated data size IE, initiate a subsequent read operation according to the updated memory pointer IE and the updated data size IE, and transmit a subsequent AIoT NAS message that indicates a result of the subsequent read operation.

In some implementations of the device, the processor, and the method described herein, the first AIoT NAS message may be a write command NAS message that includes a memory pointer IE that indicates a start address within the at least one memory and an AIoT data IE that indicates data to be stored in the at least one memory. In some implementations of the device, the processor, and the method described herein, the device, the processor, and the method may further be configured to, capable of, or operable to initiate, in response to the first AIoT NAS message, a write operation to store the data in the at least one memory according to the memory pointer IE and the AIoT data IE.

In some implementations of the device, the processor, and the method described herein, the second AIoT NAS message may indicate a failure cause based on a failure result of the write operation.

In some implementations of the device, the processor, and the method described herein, the second AIoT NAS message may be a write complete NAS message that indicates a successful result of the write operation.

In some implementations of the device, the processor, and the method described herein, the AIoT data IE may further indicate a first quantity of octets of the data, the stored data may include a second quantity of octets that is less than the first quantity of octets indicated by the AIoT data IE, and the second AIoT NAS message may be a write complete NAS message that includes a data size IE that indicates the second quantity of octets.

In some implementations of the device, the processor, and the method described herein, the device, the processor, and the method may further be configured to, capable of, or operable to receive a subsequent write command NAS message that indicates, based on the second quantity of octets, an updated memory pointer IE and an updated AIoT data IE, initiate a subsequent write operation according to the updated memory pointer IE and the updated AIoT data IE, and transmit a subsequent AIoT NAS message that indicates a result of the subsequent write operation.

In some implementations of the device, the processor, and the method described herein, the first AIoT NAS message may be a disable command NAS message, the second AIoT NAS message may be a disable complete NAS message, and the device, the processor, and the method may further be configured to, capable of, or operable to disable, subsequent to transmitting the disable complete NAS message, generation of modulation signals, and disable, subsequent to transmitting the disable complete NAS message, transmission of responses to inventory request messages.

In some implementations of the device, the processor, and the method described herein, the disable command NAS message may indicate one or more activation criteria for resuming operation of the device. In some implementations of the device, the processor, and the method described herein, the device, the processor, and the method may further be configured to, capable of, or operable to monitor one or more conditions corresponding to the one or more activation criteria, and in response to determining, based on the monitoring, that at least one activation criterion of the one or more activation criteria is met, resume generation of modulation signals and transmission of responses to inventory request messages.

An NE (e.g., implementing an AIoTF) for wireless communication is described. The NE may be configured to, capable of, or operable to perform one or more operations as described herein. For example, the NE may be configured to, capable of, or operable to transmit, to an AIoT device, a first AIoT NAS message that includes a security header type, a message authentication code, and a message type, and receive, from the AIoT device in response to the first AIoT NAS message, a second AIoT NAS message that includes the security header type, the message authentication code, and the message type indication.

A processor (e.g., a standalone processor chipset, or a component of an NE implementing an AIoTF) for wireless communication is described. The processor may be configured to, capable of, or operable to perform one or more operations as described herein. For example, the processor may be configured to, capable of, or operable to transmit, to an AIoT device, a first AIoT NAS message that includes a security header type, a message authentication code, and a message type, and receive, from the AIoT device in response to the first AIoT NAS message, a second AIoT NAS message that includes the security header type, the message authentication code, and the message type indication.

A method performed or performable by an NE (e.g., implementing an AIoTF) for wireless communication is described. The method may include transmitting, to an AIoT device, a first AIoT NAS message that includes a security header type, a message authentication code, and a message type, and receiving, from the AIoT device in response to the first AIoT NAS message, a second AIoT NAS message that includes the security header type, the message authentication code, and the message type indication.

In some implementations of the NE, the processor, and the method described herein, the first AIoT NAS message may be a read command NAS message that includes a memory pointer IE that indicates a start address within a memory of the AIoT device and a data size IE that indicates a first quantity of octets of data to be retrieved from the memory. In some implementations of the NE, the processor, and the method described herein, the NE, the processor, and the method may further be configured to, capable of, or operable to initiate a read operation timer in response to transmitting the first AIoT NAS message, and stop the read operation timer in response to receiving the second AIoT NAS message.

In some implementations of the NE, the processor, and the method described herein, the second AIoT NAS message may be a read complete NAS message that includes an AIoT data IE with an AIoT data length equal to a second quantity of octets, the second quantity of octets may be less than the first quantity of octets indicated by the data size IE. In some implementations of the NE, the processor, and the method described herein, the NE, the processor, and the method may further be configured to, capable of, or operable to transmit a subsequent read command NAS message that indicates, based on the second quantity of octets, an updated memory pointer IE and an updated data size IE, and receive a subsequent AIoT NAS message that indicates a result of a subsequent read operation.

In some implementations of the NE, the processor, and the method described herein, the first AIoT NAS message may be a write command NAS message that includes a memory pointer IE that indicates a start address within a memory of the AIoT device and an AIoT data IE that indicates data to be stored in the memory. In some implementations of the NE, the processor, and the method described herein, the NE, the processor, and the method may further be configured to, capable of, or operable to initiate a write operation timer in response to transmitting the first AIoT NAS message, and stop the write operation timer in response to receiving the second AIoT NAS message.

In some implementations of the NE, the processor, and the method described herein, the AIoT data IE may further indicate a first quantity of octets of the data, the second AIoT NAS message may be a write complete NAS message that includes a data size IE that indicates a second quantity of octets, the second quantity of octets may be less than the first quantity of octets. In some implementations of the NE, the processor, and the method described herein, the NE, the processor, and the method may further be configured to, capable of, or operable to transmit a subsequent write command NAS message that indicates, based on the second quantity of octets, an updated memory pointer IE and an updated AIoT data IE, and receive a subsequent AIoT NAS message that indicates a result of a subsequent write operation.

In some implementations of the NE, the processor, and the method described herein, the first AIoT NAS message may be a disable command NAS message to disable operation of the AIoT device, the second AIoT NAS message may be a disable complete NAS message. The NE or processor may initiate a disable operation timer in response to transmitting the first AIoT NAS message, and stop the disable operation timer in response to receiving the second AIoT NAS message.

### BRIEF DESCRIPTION OF THE DRAWINGS

FIG. 1 illustrates an example of a wireless communications system in accordance with aspects of the present disclosure.

FIG. 2 illustrates an example of a signaling diagram, in accordance with aspects of the present disclosure.

FIGS. 3A and 3B illustrate examples of AIoT NAS message formats, in accordance with aspects of the present disclosure.

FIGS. 4A and 4B illustrate examples of security protected AIoT NAS messages, in accordance with aspects of the present disclosure.

FIG. 5 illustrates an example of an inventory report AIoT NAS message, in accordance with aspects of the present disclosure.

FIGS. 6A through 6C illustrate examples of inventory report AIoT NAS messages, in accordance with aspects of the present disclosure.

FIGS. 7A and 7B illustrate examples of read command AIoT NAS messages, in accordance with aspects of the present disclosure.

FIGS. 8A and 8B illustrate examples of read complete AIoT NAS messages, in accordance with aspects of the present disclosure.

FIG. 9 illustrates an example of a read failure AIoT NAS message, in accordance with aspects of the present disclosure.

FIGS. 10A and 10B illustrate examples of write command AIoT NAS messages, in accordance with aspects of the present disclosure.

FIGS. 11A, 11B, and 11C illustrate examples of write complete AIoT NAS messages, in accordance with aspects of the present disclosure.

FIG. 12 illustrates an example of a write failure AIoT NAS message, in accordance with aspects of the present disclosure.

FIGS. 13A and 13B illustrate examples of disable command AIoT NAS messages, in accordance with aspects of the present disclosure.

FIG. 14 illustrates an example of disable complete AIoT NAS message, in accordance with aspects of the present disclosure.

FIGS. 15A, 15B, and 15C illustrate examples of security header formats, in accordance with aspects of the present disclosure.

FIGS. 16A and 16B illustrate examples of authentication response IEs, in accordance with aspects of the present disclosure.

FIG. 17 illustrates an example of a message authentication code IE, in accordance with aspects of the present disclosure.

FIG. 18 illustrates an example of a memory bank IE, in accordance with aspects of the present disclosure.

FIG. 19 illustrates an example of a memory pointer IE, in accordance with aspects of the present disclosure.

FIG. 20 illustrates an example of a data size IE, in accordance with aspects of the present disclosure.

FIG. 21 illustrates an example of an AIoT data IE, in accordance with aspects of the present disclosure.

FIG. 22 illustrates an example of a failure cause IE, in accordance with aspects of the present disclosure.

FIG. 23 illustrates an example of an activation criteria IE, in accordance with aspects of the present disclosure.

FIG. 24 illustrates an example of an environmental conditions IE, in accordance with aspects of the present disclosure.

FIG. 25 illustrates an example of a time conditions IE, in accordance with aspects of the present disclosure.

FIG. 26 illustrates an example of a location IE, in accordance with aspects of the present disclosure.

FIG. 27 illustrates an example of a device in accordance with aspects of the present disclosure.

FIG. 28 illustrates an example of a processor in accordance with aspects of the present disclosure.

FIG. 29 illustrates an example of an NE in accordance with aspects of the present disclosure.

FIG. 30 illustrates a flowchart of a method performed by a device in accordance with aspects of the present disclosure.

FIG. 31 illustrates a flowchart of a method performed by an NE in accordance with aspects of the present disclosure.

### DETAILED DESCRIPTION

An AIoT device refers to a low-power (e.g., self-powered) sensor or device, which is typically small and/or low-cost. AIoT devices are battery-less or have limited energy storage capability (e.g., using a capacitor) and the energy for the AIoT devices is provided through the harvesting of radio waves, light, motion, heat, or any other power source that could be seen suitable. Because AIoT devices are low complexity, maintenance free, have a long life span (e.g., more than 10 years), and a relatively small size, they can be deployed in numerous scenarios and locations. Compared to previously defined 3rd generation partnership project (3GPP) Internet of Things (IoT) devices (e.g., narrowband IoT (NB-IoT) or enhanced machine type communication (eMTC) devices), AIoT devices may have reduced capabilities and lower power consumption. Additionally, unlike a 3GPP-defined UE, AIoT devices may lack a universal subscriber identity module (USIM).

A wireless communications system can implement one or more network functions to support communication (e.g., transmission and reception of signaling) between different AIoT devices and/or between the AIoT devices and other devices in the wireless communications system, including UEs and NEs. For example, the wireless communications system can implement an AIoT function (AIoTF) to handle AIoT protocols, data processing, and network integration. The AIoTF may implement or be implemented by a network node (e.g., a core network node), an NE, or the like.

Existing systems provide basic communication capabilities with AIoT devices, but lack a comprehensive architecture to support protocol and interface aspects for complete AIoT device integration. Specifically, there is no established AIoT NAS protocol to facilitate transport of signaling and data between AIoT devices and an AIoTF. Additionally, existing systems lack mechanisms within the AIoT NAS to implement AIoT security features, such as privacy protection for AIoT device identifiers and authentication between AIoT devices and a 5G core network. While it has been established that every AIoT NAS message should conform to a standard layer 3 (L3) message format, only an initial organization of AIoT NAS messages has been broadly outlined, lacking detailed specifications. Due to its complexity and resource requirements, the 5GS NAS protocol is unsuitable for AIoT devices, which are characterized (e.g., as a result of low cost, battery-less operation) by minimal processing and memory capabilities that are unable to accommodate the extensive security, authentication, and signaling procedures mandated by standard 5GS NAS protocols. Consequently, a more lightweight and simplified protocol is desired to effectively support AIoT devices within wireless communication systems.

The techniques described herein provide a lightweight and simplified (e.g., as compared to 5G NAS) AIoT NAS protocol designed for low-cost, battery-less AIoT devices with limited processing and memory capabilities. This protocol utilizes a security framework that provides integrity protection and optional confidentiality protection (e.g., encryption) while remaining efficient for resource-constrained devices. The protocol further includes signaling and encoding for memory access operations that enable secure reading and writing of data to AIoT device storage; partial read/write operations that allow reliable data exchange even under strict energy and time constraints; and device control mechanisms including a disable command with optional reactivation criteria. The protocol defines standardized message formats and IEs that ensure message integrity and confidentiality without imposing excessive computational burden on AIoT devices.

For example, an AIoT device may receive (e.g., communicate, from an AIoTF, an NE, a UE, etc.) an AIoT NAS message that includes a security header type, a message authentication code, and a message type. The AIoT NAS message may include or be an example of a command request, such as a read command or a write command, including one or more IEs and structured according to a corresponding format as described herein. For example, the security header may be carried in an initial (e.g., first) octet of the AIoT NAS message. The AIoT device may initiate an operation (e.g., a read operation, a write operation) based on receiving the AIoT NAS message. In some cases, the AIoT NAS message may be a disable command that instructs the AIoT device to cease operations, based on which the AIoT device may disable generation of modulation signals and responses to inventory request messages. After performing the operation, the AIoT device may transmit (e.g., send, communicate) an AIoT NAS response message to an AIoTF indicating a result (e.g., a failure result, a success result, a partial success result) of the operation. The AIoT NAS response message may include one or more IEs and may be structured according to a corresponding format as described herein.

The techniques described herein enable secure and efficient communication between AIoT devices and NEs (or other devices). Compared to 5G NAS protocols that are computationally complex and resource-intensive, the described techniques support a NAS protocol that accommodates the unique constraints of ambient-powered devices, such as limited processing and memory capabilities. For example, the message and IE formats defined herein are compact and simplified by avoiding type fields and length information, and utilizing fixed-length headers and value fields. These formats also reduce overall message length and reduce overhead by removing or reducing extraneous content, such as optional IEs that require added IE type and length fields. Additionally, the lightweight security framework ensures message integrity and confidentiality while remaining suitable for resource-constrained devices, addressing security concerns in AIoT communications.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

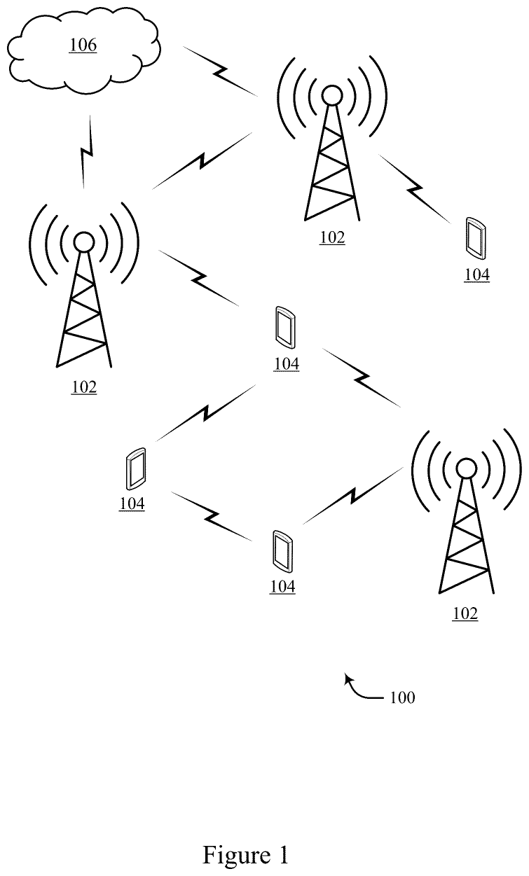

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20 and ISO18000-6C UHF RFID. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), an Ambient IoT device reader, an RFID reader, or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Ambient IoT (AIoT) device, an RFID tag, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some cases, the wireless communications system 100 may include one or more AIoT devices. An AIoT device refers to a low-power (e.g., self-powered) sensor or device, which is typically small and/or low-cost. For example, AIoT devices may include an energy harvester with an output power of from 1 microwatt (μW) to a few hundreds of μW. AIoT devices also typically do not include a SIM card. AIoT devices are battery-less or have limited energy storage capability (e.g., using a capacitor) and the energy for the AIoT devices is provided through the harvesting of radio waves, light, motion, heat, or any other power source that could be seen suitable. Thus, the AIoT device may collect and transmit data without a dedicated power source.

In one or more implementations, the AIoT device may be a sensor (e.g., a tag), an actuator, an appliance, or another device capable of connecting to a wireless network. In some examples, the AIoT device is categorized according to a set of components and/or capabilities of the AIoT devices, where the categories include one or more of an active AIoT device category, a semi-passive AIoT device category, and/or a passive AIoT device category. A passive AIoT device may operate on harvested energy without an internal power source (such as a battery), and may lack energy storage capabilities and/or an active radio frequency (RF) component (e.g., for signal generation). A semi-passive AIoT device may use a combination of harvested energy and a relatively small internal power source (e.g., that provides less than a threshold amount of power) and/or energy storage capability, and may not include an active RF component. An active AIoT device includes a power source and an active radio frequency component, such as a transmitter and/or receiver component, for signal generation.

In some cases, semi-passive AIoT devices and passive AIoT devices use backscattering techniques and/or energy harvesting for transmitting and/or receiving transmissions. In variations, an active AIoT device may use a transmitter and/or receiver component for transmitting or receiving transmissions and/or may use backscattering techniques for transmitting and/or receiving transmissions. Semi-passive AIoT devices may use the stored energy to amplify a signal when using backscattering techniques. Backscattering techniques include receiving signaling from a source device (e.g., a node such as an intermediate node) and modulating a reflection of the incoming signaling towards a destination device (e.g., a reader node such as an intermediate node). Thus, the AIoT device may not use an active receiver and/or transmitter component for receiving and transmitting signaling, which reduces a power consumption level of the device.

An AIoT device may be classified or defined as a low power device if a power consumption level of the AIoT device satisfies (e.g., is less than) a threshold value. The AIoT device may include a low power processor to reduce the power consumption level of the AIoT device, which may be a processor that operates with a power consumption level that satisfies (e.g., is less than) a threshold value. A low power processor and/or the AIoT device may have reduced functionality when compared with a processor or other wireless device that operates at a power consumption level that is greater than the threshold values. For example, the low power processor and/or the AIoT device may have reduced processing capabilities for decoding and generating signaling, may have reduced transmission and/or reception capabilities (e.g., reduced transmission and/or reception range, among others), reduced energy storage capabilities (e.g., smaller or no battery), or the like when compared with a processor or wireless device that operates at a power consumption level that is greater than the threshold values.

The techniques discussed herein do not rely on devices having a SIM or USIM and thus work with AIoT devices. Additionally, the techniques discussed herein do not rely on a USIM as a primary basis for the security, confidentiality, and integrity protection. The techniques discussed herein also work with low-power devices (e.g., AIoT devices that harvest energy from their environment) and do not require large batteries for long lasting operation or a fixed power supply.

In some examples, the wireless communications system 100 may include one or more AIoT readers that interact with AIoT devices. In some examples, an AIoT reader may be a UE 104 that communicates with an NE 102. For example, a UE 104 acting as an AIoT reader may collect data from nearby AIoT sensors and relay the data to the network through an NE 102. In some other examples, an AIoT reader may be an NE 102 that communicates directly with AIoT devices within a coverage area of the NE 102. The AIoT reader may provide radio frequency energy for the AIoT device to harvest, as well as receive data transmitted by the AIoT device.

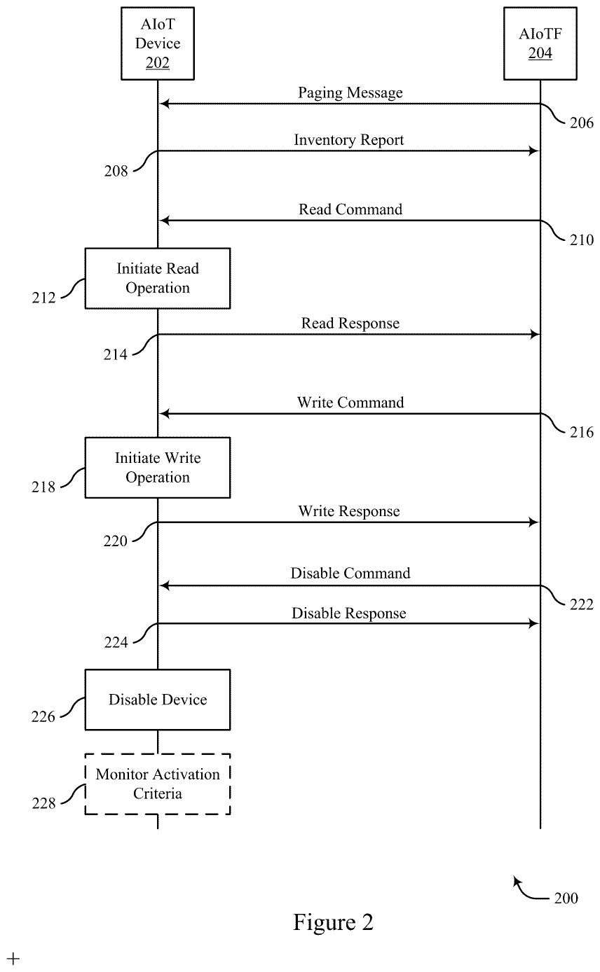

The wireless communications system 100 may implement a network architecture that includes various network functions to manage and control communication between devices, such as described in further detail with respect to FIG. 2. The network functions may be implemented as software modules, virtual network elements, or dedicated hardware components within the network infrastructure. Devices, such as NEs 102 or UEs 104, may communicate with the network functions through standardized interfaces and protocols, enabling seamless integration and operation within the network. In some cases, devices (e.g., network entities, NEs 102, and/or UEs 104) may implement or otherwise include one or more network functions directly. For example, an NE 102, a core network node, or another network device may host multiple network functions responsible for different tasks, such as mobility management, session control, or policy enforcement. Similarly, a UE 104 may incorporate network function capabilities to enhance performance and reduce signaling overhead with the core network.

The network architecture may include one or more dedicated functions for managing AIoT communications. For example, the network architecture can include an AIoTF to manage AIoT protocols, data processing, and network integration. The AIoTF may manage communications between AIoT devices and the networks, coordinating energy harvesting and communication (e.g., control signaling or data exchange). The wireless communications system 100 may include one or more devices (e.g., network entities, NEs, and/or other network devices) that implement network functions such as the AIoTF. For example, an NE 102 can implement the AIoTF in hardware or software executed at the NE 102. Additionally, or alternatively, the AIoTF may be implemented as part of the CN 106.

According to implementations, one or more of the NEs 102 and AIoT devices are operable to implement various aspects of the techniques described with reference to the present disclosure. For example, an AIoT device may receive, from an AIoTF, a first AIoT NAS message that includes a security header type, a message authentication code, and a message type. The first AIoT NAS message may be a command request message, based on which the AIoT device initiates a corresponding operation. The AIoTF may start a corresponding timer upon transmission of the first AIoT NAS message. The AIoT device may transmit, in response to the first AIoT NAS message, a second AIoT NAS message that includes the security header type, the message authentication code, and the message type indication. In some examples, the second AIoT NAS message indicates a result (e.g., a success result, a failure result, a partial success result) of the operation. The AIoTF may stop the corresponding timer upon reception of the second AIoT NAS message.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

FIG. 2 illustrates an example of a signaling diagram 200 in accordance with aspects of the present disclosure. In some examples, the signaling diagram 200 implements or is implemented by aspects of the wireless communications system 100. For example, the signaling diagram 200 includes an AIoT device 202 and an AIoTF 204, which may be examples of corresponding devices as described with reference to FIG. 1. Alternative examples of the following may be implemented, where some processes are performed in a different order than described or are not performed. In some cases, processes may include additional features not mentioned below, or further processes may be added.

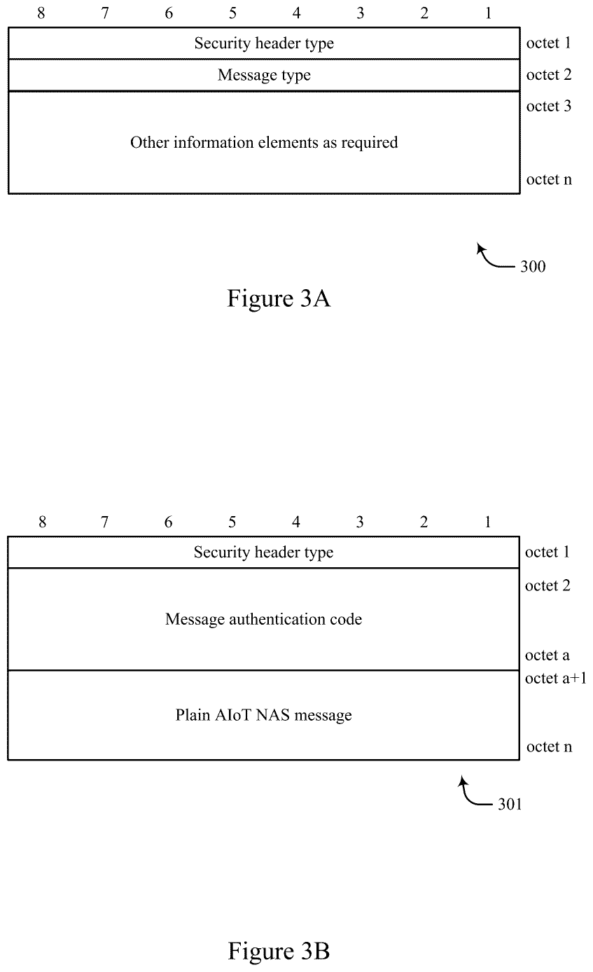

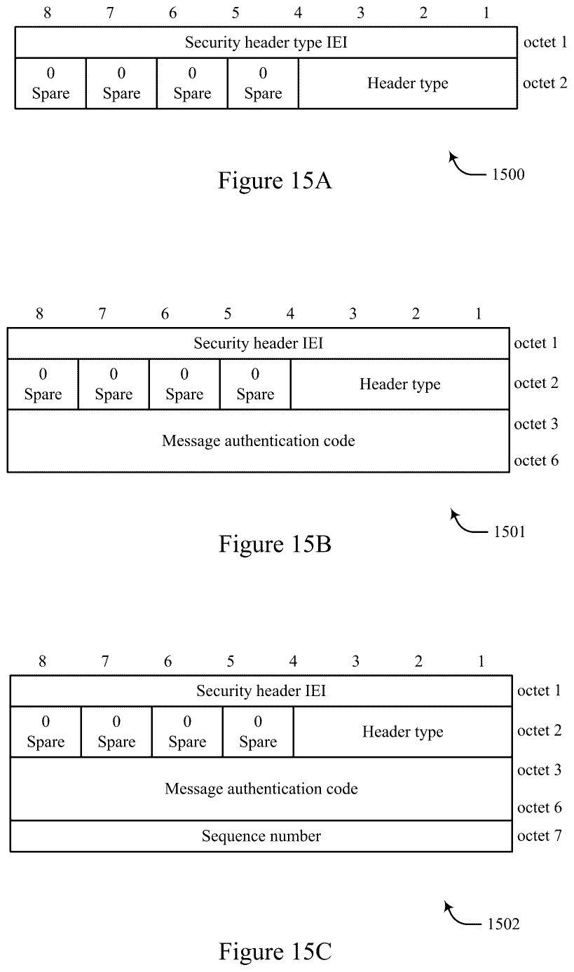

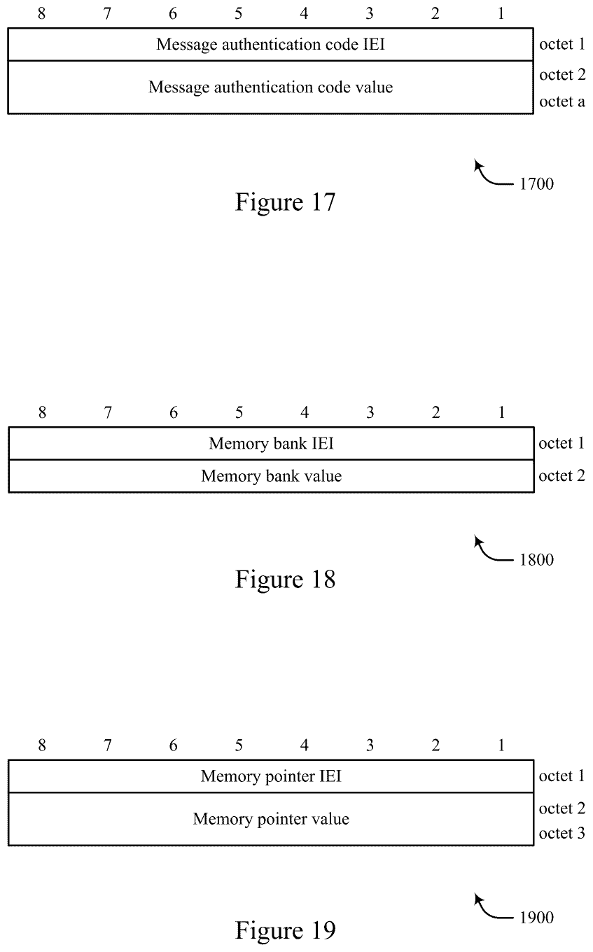

The signaling diagram 200 illustrates the exchange of AIoT NAS messages between the AIoT device 202 and the AIoTF 204 according to a lightweight NAS protocol. The AIoT NAS messages and their contents (e.g., IE(s)) may be structured (e.g., organized) according to formats as described with reference to FIGS. 3-26. The AIoT NAS messages enable the AIoT device 202 and the AIoTF 204 to implement one or more procedures (e.g., inventory request procedures, command procedures). For example, the AIoTF 204 initiates one or more requests (e.g., inventory requests and/or command requests carried in AIoT NAS messages) targeting the AIoT device 202, which performs one or more operations based on receiving the request(s). The AIoTF 204 takes various actions based on responses (e.g., AIoT NAS messages) received from the AIoT device 202. Throughout this signaling exchange, both the AIoT device 202 and the AIoTF 204 may verify the integrity of received AIoT NAS messages using a message authentication code included in each AIoT NAS message. The message authentication code may be carried in a separate message authentication code IE as described with reference to FIG. 17 or included in a security header IE as described with reference to FIGS. 15B to 15C. Additionally, each AIoT NAS message includes a security header type carried in a separate security header type IE as described with reference to FIG. 15A or included in a security header IE as described with reference to FIGS. 15B through 15C, both in an initial octet of the corresponding AIoT NAS message. The security header type may indicate a security status (e.g., unprotected, integrity protected, integrity and confidentiality protected) of the corresponding AIoT NAS message.

Security protection involves integrity protection and, if applicable, confidentiality protection of AIoT NAS messages. In some implementations, at least one of the AIoT NAS messages may be an unprotected AIoT NAS message encapsulated in a security protected AIoT NAS message, where the security protected AIoT NAS message includes, in one or more IEs, the security header type, the message authentication code, and/or a sequence number (e.g., for replay protection). In some cases, the security header type, the message authentication code, and/or the sequence number are contained in a single IE (e.g., the security header IE). In some examples, integrity protection is mandatory for all AIoT NAS signaling messages exchanged between the AIoT device 202 and the AIoTF 204.

When an AIoT NAS signaling message is integrity protected, it is first ciphered (e.g., by a transmitting device, such as the AIoT device 202 or the AIoTF 204) using either an NEA0 algorithm (without confidentiality protection) or an 128-NEA2 algorithm (with confidentiality protection), and then the ciphered AIoT NAS message is integrity protected by calculating the message authentication code using the 128-NIA2 algorithm. The AIoT device 202 will not process any AIoT NAS signaling message unless it has successfully passed integrity verification, discarding any AIoT NAS message that fails verification or lacks integrity protection. Similarly, the AIoTF 204 performs integrity verification on all received AIoT NAS signaling messages from the AIoT device 202, discarding any message that fails verification. Confidentiality protection is an operator option subject to AIoTF 204 configuration. When operating without confidentiality protection, the AIoTF 204 indicates “integrity protected” in the security header type and ciphers AIoT NAS messages using the NEA0 algorithm. When operating with confidentiality protection, the AIoTF 204 indicates “integrity and confidentiality protected” in the security header type and ciphers AIoT NAS messages using the 128-NEA2 algorithm.

An inventory request procedure may be initiated by the AIoTF 204 to discover and identify AIoT devices, such as the AIoT device 202, within a coverage area. This procedure allows the AIoTF 204 to gather essential information about the AIoT device 202, such as its identity, capabilities, and current status. For example, at 206, the AIoTF 204 sends (e.g., communicates, transmits) a paging message to the AIoT device 202. Upon reception of the paging message, the AIoT device 202 determines whether to respond to the paging message based on an indication from a lower layer or based on filtering information received from the lower layer. In the latter example, the AIoT device 202 may determine whether the filtering information matches the permanent identifier of the AIoT device 202 and, if so, may determine to respond to the paging message. If the filtering information matches the permanent identifier, the AIoT device 202 may indicate that the filtering information is matched to the lower layer. Otherwise, the AIoT device may ignore the filtering information and determine to refrain from responding to the AIoT paging.

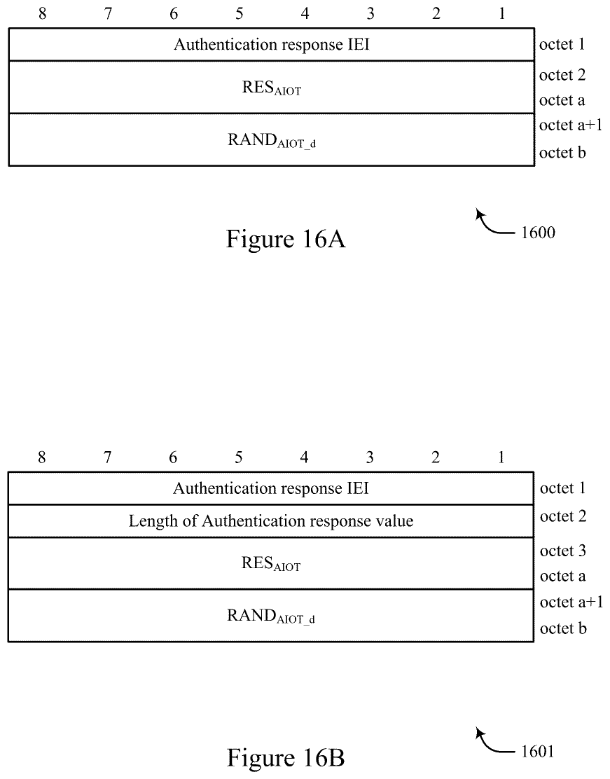

If the AIoT device 202 determines to respond to the paging message, the AIoT device 202 may initiate an inventory report message toward the AIoTF 204. For example, at 208, in response to receiving the paging message, the AIoT device 202 sends (e.g., communicates, transmits) an inventory report message (e.g., an AIoT inventory report NAS message) as described herein. The inventory report message may be an AIoT inventory report NAS message that includes one or more of the security header, an AIoT device identity (e.g., carried in an AIoT device identity IE) of the AIoT device 202, and/or an authentication response IE (e.g., as defined with reference to FIGS. 16A and 16B) that includes a random challenge (RAND) and an authentication response parameter (RES). In some examples, the paging message includes or is an example of a media access control (MAC) protocol data unit (PDU) or a radio resource control (RRC) message.

In some examples, during the inventory request procedure, the AIoTF 204 may authenticate (e.g., initiate an authentication procedure with) the AIoT device 202 to ensure secure communication between the AIoTF 204 and the AIoT device 202. The authentication is based on a challenge-response mechanism. The paging message communicated at 206 may include a network-generated random challenge (RAND_{AIoT_n}). Upon receiving the paging message including RAND_{AIoT_n} and determining to respond, the AIoT device 202 derives (e.g., generates, computes) one or more authentication parameters including a response (RES_{AIoT}) and, in some cases, a device nonce (RAND_{AIoT_d}). The AIoT device 202 includes the authentication parameter(s) in the authentication response IE of the inventory report message sent to the AIoTF 204 at 208. The inventory report message also contains the AIoT device identity IE to identify the AIoT device 202 to the network. The authentication procedure is completed when the AIoT device 202 transmits the inventory report message containing the authentication response IE to the AIoTF 204, establishing a secure communication channel for subsequent message exchanges such as read commands, write commands, and disable commands.

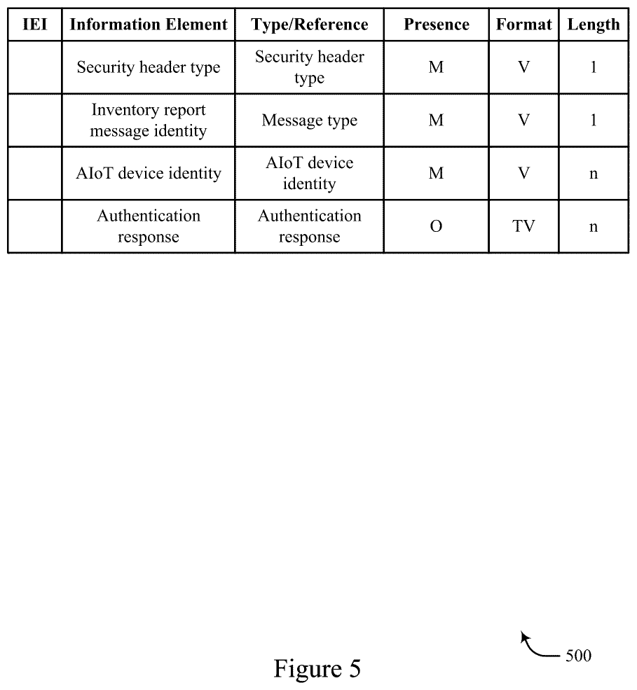

In some examples, the contents included in the inventory report message initiated by the AIoT device 202 may depend on whether the paging message includes the random challenge. For example, as described with reference to FIG. 5, only one type (i.e., format) of inventory report message may be defined, in which the authentication response IE is an optional IE. Here, the AIoT device 202 includes the authentication response IE (e.g., containing the authentication parameter(s)) in the inventory report message if the paging message received at 206 includes the random challenge. If the paging message does not include the random challenge, the AIoT device 202 omits the authentication response IE from the inventory report message.

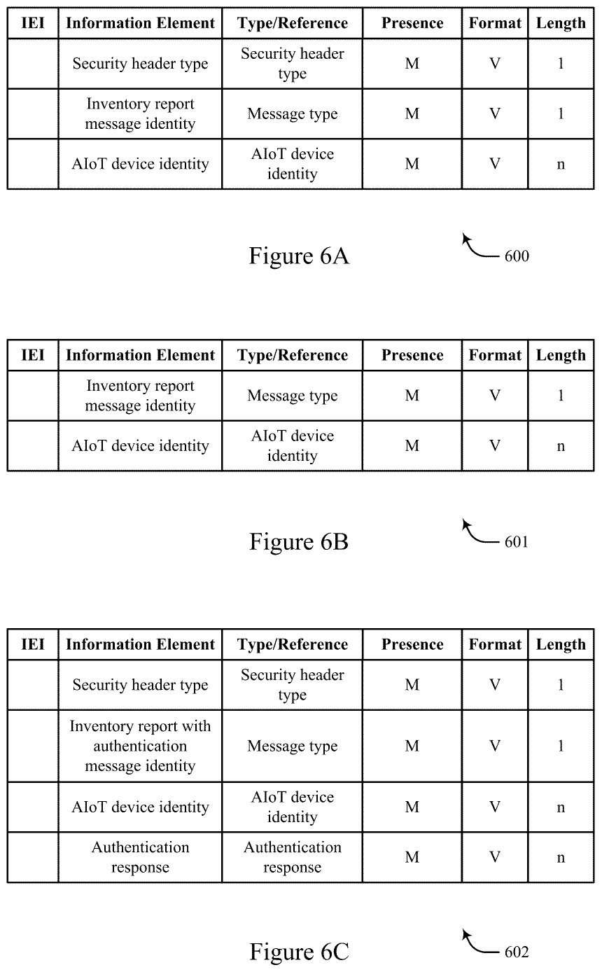

Alternatively, as described with reference to FIGS. 6A-6C, two or more types (i.e., formats) of inventory report message are defined: an “inventory report message” (as illustrated in FIGS. 6A and 6B), utilized when the paging message does not include the random challenge, and an “inventory report with authentication message” (as illustrated in FIG. 6C), utilized when the paging message does include the random challenge. In this example, the inventory report message includes the AIoT device identity IE and, in some cases, the security header, while the inventory report with authentication message includes the security header, the AIoT device identity IE, and the authentication response IE (e.g., as a mandatory, rather than optional, IE).

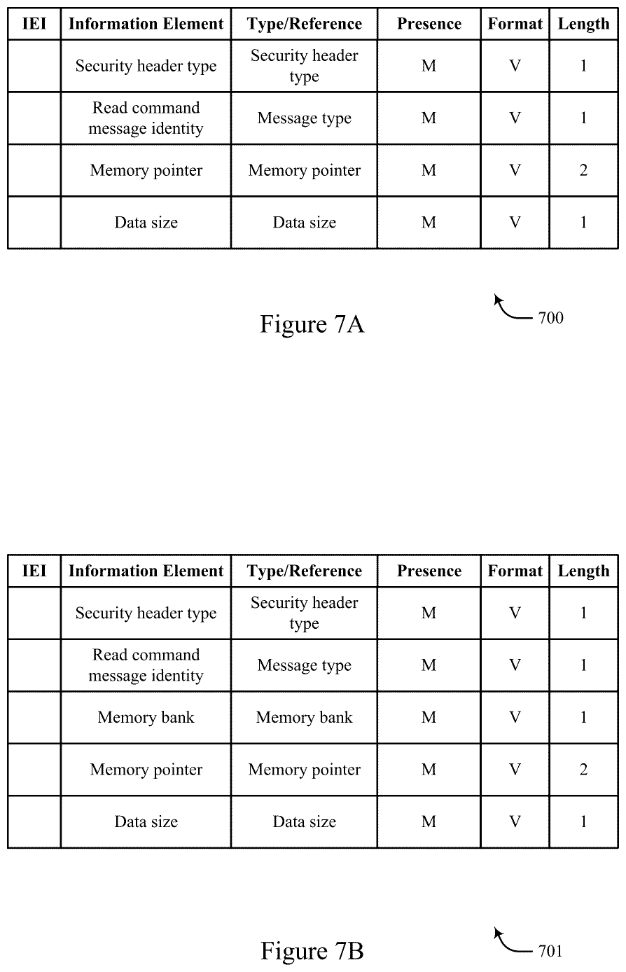

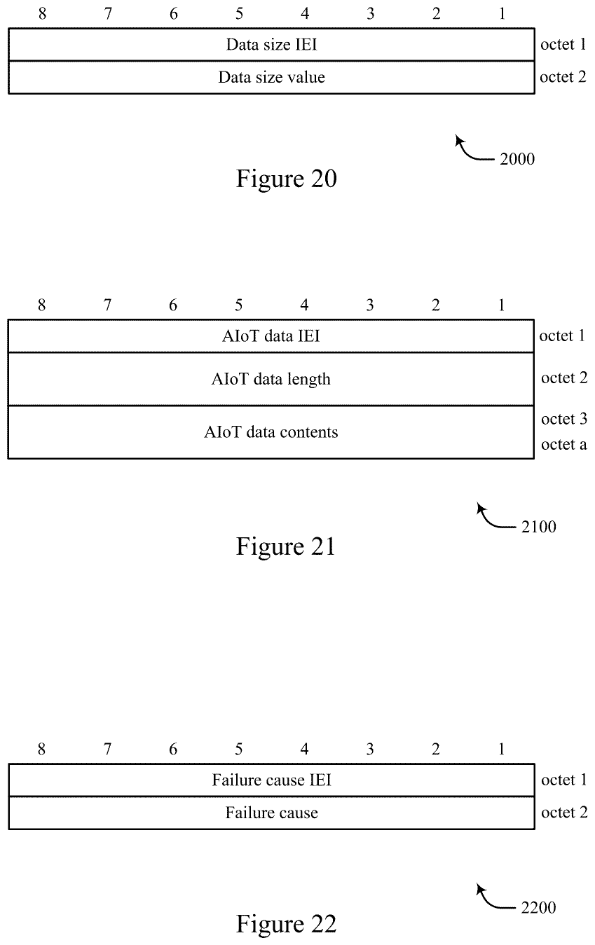

A command procedure is utilized by the AIoTF 204 to retrieve data from a memory (e.g., a memory bank) of the AIoT device 202, store data in a memory (e.g., a memory bank) of the AIoT device 202, and/or disable the AIoT device 202. A read command procedure, also referred to as a read operation, enables the AIoTF 204 to retrieve data from the memory of the AIoT device 202. For example, at 210, the AIoTF 204 initiates the read command procedure by sending (e.g., transmitting, communicating) a read command AIoT NAS message (e.g., as defined with reference to FIGS. 7A and 7B) to the AIoT device 202. In some examples, when initiating the read command procedure at 210, the AIoTF 204 also starts a timer (e.g.,. a read operation timer). The AIoTF 204 includes, in the read command AIoT NAS message, a memory pointer IE (e.g., as defined with reference to FIG. 19) that specifies a start address within the memory of the AIoT device 202 for the read operation, and a data size IE (e.g., as defined with reference to FIG. 20) that indicates a quantity of octets to be retrieved from the memory of the AIoT device 202. In some cases, the AIoT device 202 includes multiple memory banks, such as a reserved memory, an electronic product code (EPC) memory, a tag identifier (TID) memory, and/or a user memory. The AIoTF 204 may include, in the read command AIoT NAS message, a memory bank IE (e.g., as defined with reference to FIG. 18) that indicates a memory bank from which to retrieve the indicated data.

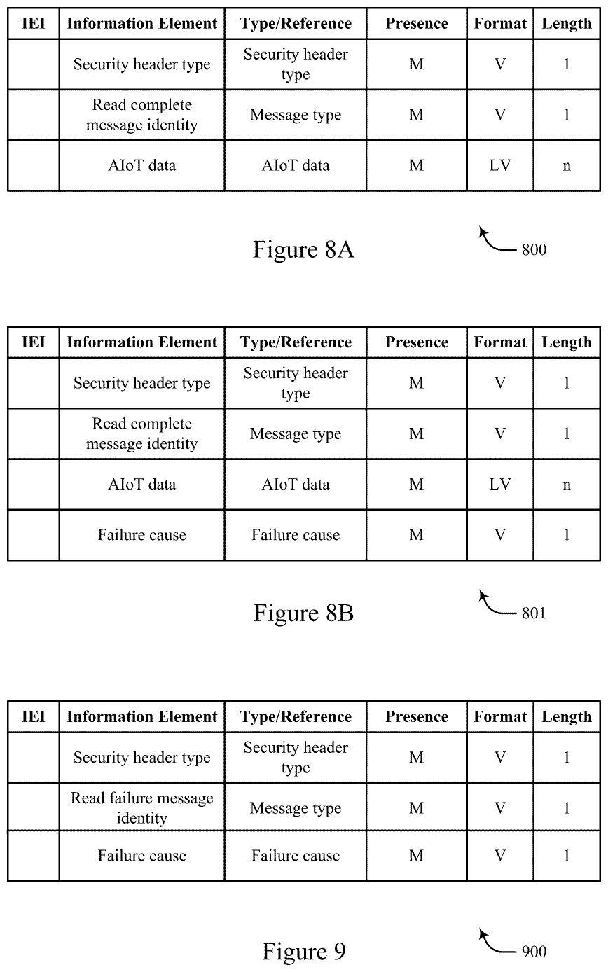

At 212, based on receiving the read command AIoT NAS message at 210, the AIoT device 202 utilizes the message contents to perform the requested read operation on the (indicated) memory of the AIoT device 202. For example, the AIoT device 202 may retrieve a quantity of data octets equal to the quantity indicated by the data size IE stored at the start address indicated by the memory pointer IE. At 214, the AIoT device 202 sends (e.g., transmits, communicates), in response to the read command AIoT NAS message, an AIoT NAS message that indicates a result of the read operation. For example, upon successful completion of the read operation (e.g., upon successful retrieval of the requested data), the AIoT device 202 may send a read complete AIoT NAS message (e.g., as defined with reference to FIGS. 8A and 8B) to the AIoTF 204 at 214. The read complete AIoT NAS message may implicitly or explicitly indicate a success result of the read operation and may include an AIoT data IE (e.g., as defined with reference to FIG. 21) carrying the data retrieved from the memory of the AIoT device 202.

In some examples, the AIoT device 202 may have limited time and/or energy resources for completing command procedures. For instance, the AIoT device 202 may not be capable of harvesting sufficient energy to retrieve the full quantity of octets indicated by the data size IE in the read command AIoT NAS message. If unable to retrieve the indicated data, the AIoT device 202 may determine that the read operation has failed, and may indicate a failure result to the AIoTF 204 at 214. For example, the AIoT device 202 may send (e.g., transmit, communicate) a read failure AIoT NAS message (e.g., as defined with reference to FIG. 9) to the AIoTF 204 at 214. The AIoT device 202 includes a failure cause IE (e.g., as defined with reference to FIG. 22) with an appropriate failure cause code in the read failure AIoT NAS message. Alternatively, the AIoT device 202 may include the failure cause IE with an appropriate failure cause code in a read complete AIoT NAS message (e.g., as defined with reference to FIG. 8B) sent at 214. In this case, the AIoT device 202 also includes an AIoT data IE (e.g., as defined with reference to FIG. 21) with a length set to zero in the read complete AIoT NAS message. If transmission of the read failure AIoT NAS message or the read complete AIoT NAS message fails, at 214, the AIoT device 202 may abort the read operation.

Upon reception of the read failure AIoT NAS message or the read complete AIoT NAS message (e.g., at 214), the AIoTF 204 may stop the read operation timer. If the timer expires prior to reception of the read failure AIoT NAS message or the read complete AIoT NAS message, and/or if transmission failure of the read command AIoT NAS message occurs, the AIoTF 204 may abort the read command procedure.

In some cases, if the AIoT device 202 is able to retrieve a subset of the indicated data (e.g., a second quantity of octets that is less than the first quantity of octets indicated by the data size IE but greater than zero), the AIoT device 202 may support a partial read operation rather than consider the read operation a failure, thereby reducing overhead and latency. In such cases, the AIoT device 202 may still transmit, at 214, a read complete AIoT NAS message (e.g., as defined with reference to FIG. 8A) that includes the retrieved data (e.g., in the AIoT data IE) and a data size IE that indicates a length of the retrieved data (e.g., the second quantity of octets). Upon reception of a read complete AIoT NAS message, the AIoTF 204 may determine whether the second quantity of octets indicated in the data size IE of the read complete AIoT NAS message is equal to or less than the first quantity of octets indicated in the data size IE of the read command AIoT NAS message.

If the second quantity of octets is less than the first quantity of octets, the AIoTF 204 may initiate a subsequent read command procedure to retrieve the remaining data from the memory of the AIoT device 202. To this end, the AIoTF 204 uses the second quantity of octets to compute a quantity of octets and a start address of the remaining octets. The AIoTF 204 adds the second quantity of octets to the value of the start address indicated in the memory pointer IE of the initial read command AIoT NAS message (e.g., transmitted at 210) to determine an updated value (e.g., an updated start address) for the memory pointer IE. The AIoTF 204 subtracts the second quantity of octets from the first quantity of octets to determine an updated value (e.g., an updated quantity of octets) for the data size IE. To initiate the subsequent read command procedure, the AIoTF 204 transmits a subsequent read command AIoT NAS message to the AIoT device 202 including the updated memory pointer IE and the updated data size IE. Based on receiving the subsequent read command AIoT NAS message, the AIoT device 202 may initiate a subsequent read operation and transmit a subsequent AIoT NAS message indicating a result of the subsequent read operation, e.g., as described at 212 and 214. The AIoTF 204 may continue initiating subsequent read command procedures until the entirety of the data is retrieved from the AIoT device 202.

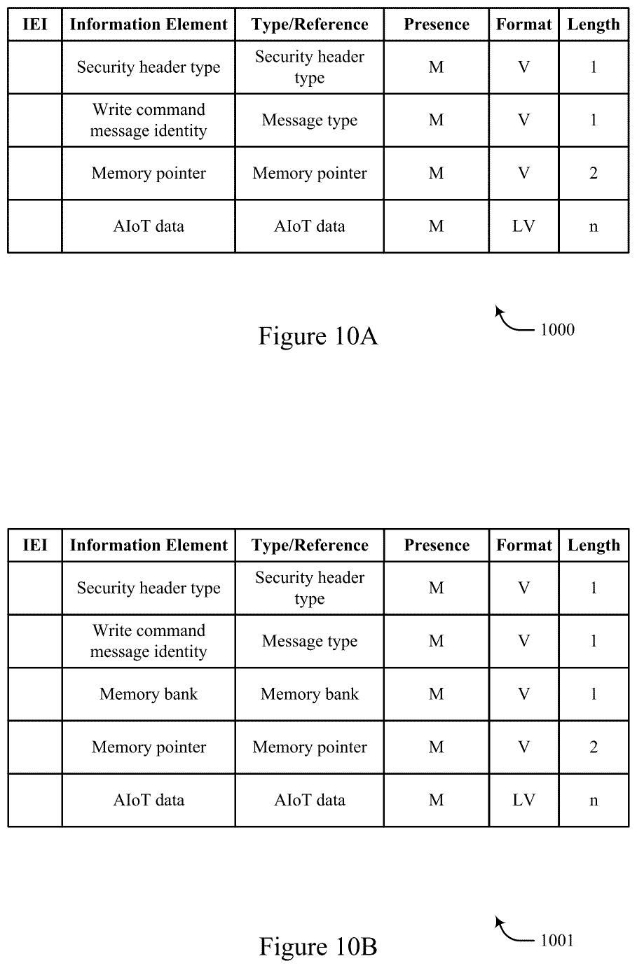

A write command procedure, also referred to as a write operation, enables the AIoTF 204 to write (i.e., store) data to the memory of the AIoT device 202. For example, at 216, the AIoTF 204 initiates the write command procedure by sending (e.g., transmitting, communicating) a write command AIoT NAS message (e.g., as defined with reference to FIGS. 10A and 10B) to the AIoT device 202. In some examples, when initiating the write command procedure at 216, the AIoTF 204 also starts a timer (e.g., a write operation timer). The AIoTF 204 includes, in the write command AIoT NAS message, a memory pointer IE (e.g., as defined with reference to FIG. 19) that specifies a start address within the memory of the AIoT device 202 for the write operation, and an AIoT data IE (e.g., as defined with reference to FIG. 21) that carries the data to be stored in the memory of the AIoT device 202. If the AIoT device 202 includes multiple memory banks, the AIoTF 204 may include, in the write command AIoT NAS message, a memory bank IE that indicates a memory bank to which the indicated data is to be written.

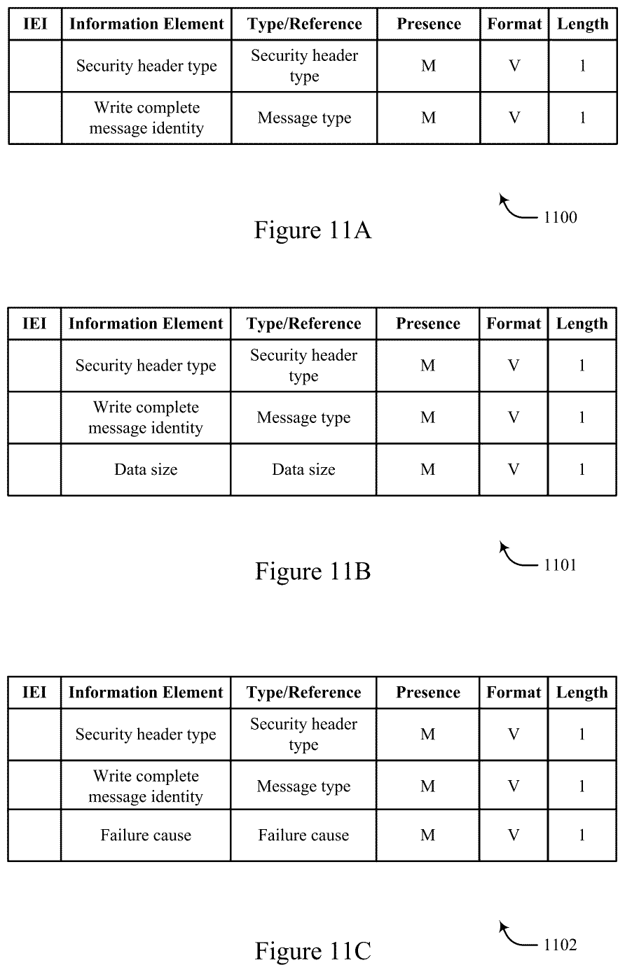

At 218, based on receiving the write command AIoT NAS message at 216, the AIoT device 202 utilizes the message contents to perform the requested write operation on the memory of the AIoT device 202. For example, the AIoT device 202 may store the data indicated by the AIoT data IE at the start address indicated by the memory pointer IE. At 220, the AIoT device 202 sends (e.g., transmits, communicates), in response to the write command AIoT NAS message, an AIoT NAS message that indicates a result of the write operation. For example, upon successful completion of the write operation (e.g., upon successful storage of the indicated data), the AIoT device 202 may send a write complete AIoT NAS message (e.g., as defined with reference to FIGS. 11A through 11C) to the AIoTF 204 at 220. The write complete AIoT NAS message may implicitly or explicitly indicate a success result of the write operation.

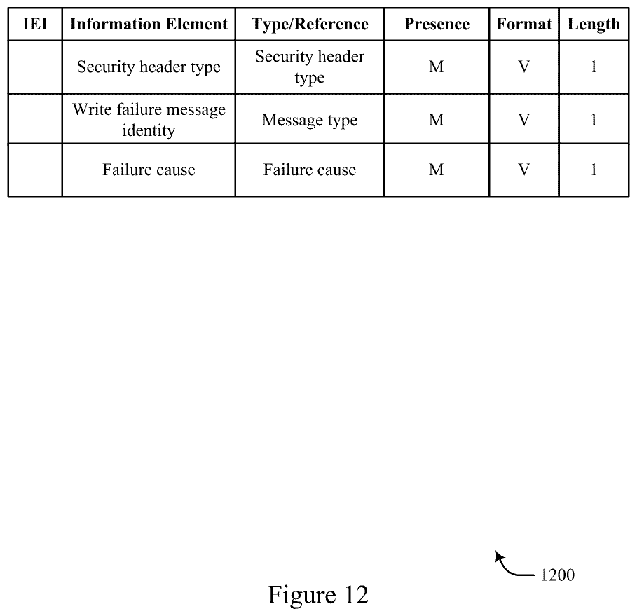

If, due to time and/or energy constraints, the AIoT device 202 is unable to write the indicated data to the memory, the AIoT device 202 may determine that the write operation has failed, and may indicate a failure result to the AIoTF 204 at 220. For example, the AIoT device 202 may send (e.g., transmit, communicate) a write failure AIoT NAS message (e.g., as defined with reference to FIG. 12) to the AIoTF 204 at 220. The AIoT device 202 includes a failure cause IE (e.g., as defined with reference to FIG. 22) with an appropriate failure cause code in the write failure AIoT NAS message. Alternatively, the AIoT device 202 may include the failure cause IE with an appropriate failure cause code in a write complete AIoT NAS message (e.g., as defined with reference to FIG. 11C) sent at 220. If transmission of the write failure AIoT NAS message or the write complete AIoT NAS message fails, at 220, the AIoT device 202 may abort the write operation.

Upon reception of the write failure AIoT NAS message or the write complete AIoT NAS message (e.g., at 220), the AIoTF 204 may stop the write operation timer. If the timer expires prior to reception of the write failure AIoT NAS message or the write complete AIoT NAS message, and/or if transmission failure of the write command AIoT NAS message occurs, the AIoTF 204 may abort the write command procedure.

In some cases, if the AIoT device 202 is able to write a subset, but not all, of the indicated data, the AIoT device 202 may support a partial write operation rather than consider the write operation a failure. In such cases, the AIoT device 202 may still transmit, at 220, a write complete AIoT NAS message (e.g., as defined with reference to FIG. 11B) that includes a data size IE that indicates a quantity of octets of data successfully written to the memory. Upon reception of a write complete AIoT NAS message, the AIoTF 204 may determine that a partial write operation has occurred based on whether the write complete AIoT NAS message includes a data size IE. If so, the AIoTF 204 may initiate a subsequent write command procedure to store the remaining data in the memory of the AIoT device 202. To this end, the AIoTF 204 removes the already-written data from the AIoT data IE and updates the memory pointer IE accordingly. The AIoTF 204 initiates the subsequent write command procedure (e.g., a subsequent write operation) by transmitting (e.g., sending, communicating) a subsequent write command AIoT NAS message to the AIoT device 202 including the updated memory pointer IE and the updated AIoT data IE. Based on receiving the subsequent write command AIoT NAS message, the AIoT device 202 may initiate a subsequent write operation and transmit a subsequent AIoT NAS message indicating a result of the subsequent write operation, e.g., as described at 218 and 220. The AIoTF 204 may continue initiating subsequent write command procedures until the entirety of the data is stored at the AIoT device 202.

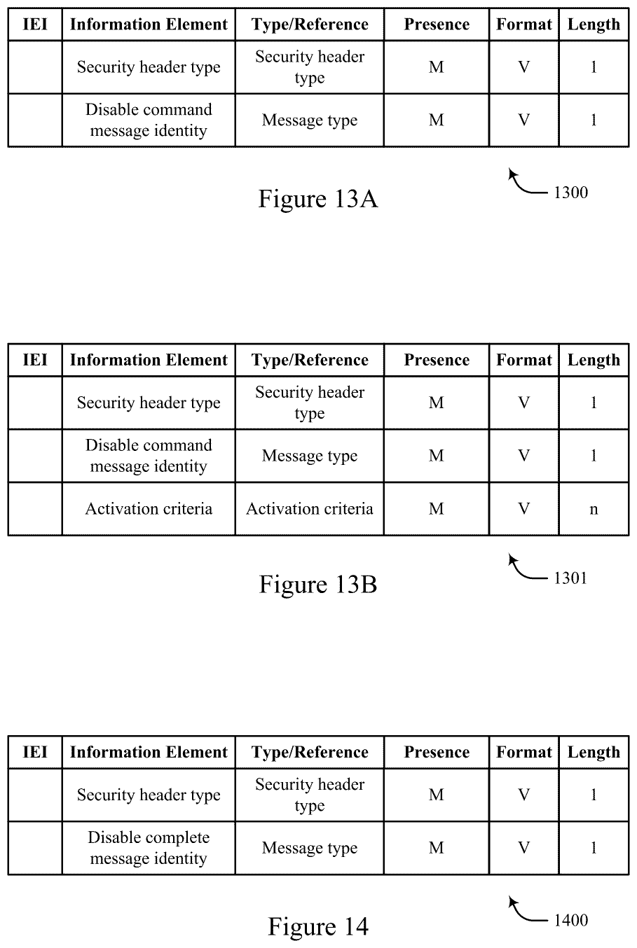

A disable command procedure, also referred to as a disable operation, enables the AIoTF 204 to stop the AIoT device from responding to inventory requests and from generating modulation signals. For example, at 222, the AIoTF 204 initiates the disable command procedure by sending (e.g., transmitting, communicating) a disable command AIoT NAS message (e.g., as defined with reference to FIGS. 13A and 13B) to the AIoT device 202. In some examples, when initiating the disable command procedure at 222, the AIoTF 204 also starts a timer (e.g., a disable operation timer).

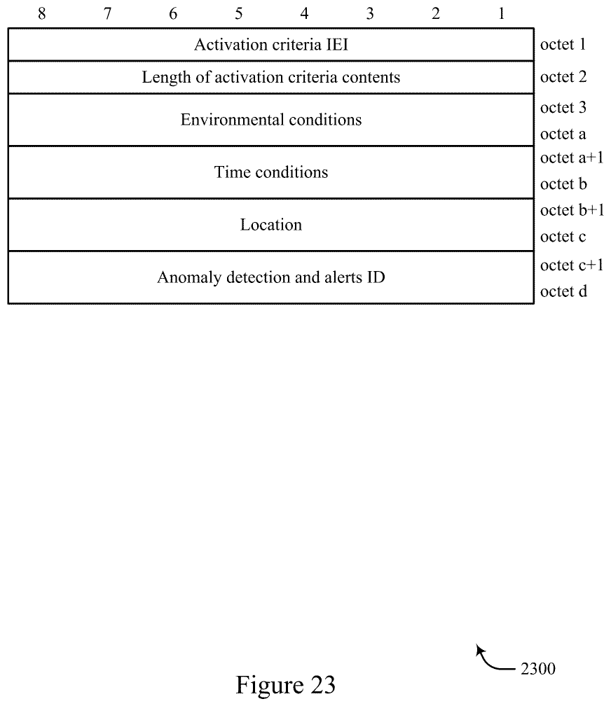

In some cases, the AIoTF 204 may temporarily disable the AIoT device 202, such as for a time duration or at a particular location, after which the AIoT device 202 may resume operations. Additionally, or alternatively, the AIoTF 204 may define activation criteria based on which AIoT device 202 is to resume operations. The ATIOF may optionally include, in the disable command AIoT NAS message, an activation criteria IE (e.g., as defined with reference to FIGS. 23-26) that indicates conditions under which the AIoT device 202 is to resume operations. The activation criteria may include, but is not limited to, environmental conditions, time information, location information, anomaly detection and alerts, or the like, among other examples.

At 224, based on receiving the disable command AIoT NAS message at 222, the AIoT device 202 utilizes the message contents to perform the requested disable operation. For example, the AIoT device 202 may send, in response to the disable command AIoT NAS message, a disable complete AIoT NAS message (e.g., as defined with reference to FIG. 14) to the AIoTF 204 at 224. The disable complete AIoT NAS message may implicitly or explicitly indicate a success result of the disable operation. After sending the disable complete AIoT NAS message, at 226, the AIoT device 202 may disable itself, e.g., by ceasing generation of modulation signals and refraining from responding to any subsequently received inventory request messages (e.g., paging messages). However, if transmission of the disable complete AIoT NAS message fails, at 224, the AIoT device 202 may abort the disable operation.

If the activation criteria IE is included in the disable command AIoT NAS message, at 228, the AIoT device 202 may monitor for the indicated conditions. Upon detection that a condition is satisfied (e.g., an indicated threshold is satisfied, an indicated time window or location is detected, etc.), the AIoT device 202 may resume operations by resuming generation of modulation signals and responding to subsequently received inventory request messages.

Upon reception of the disable complete AIoT NAS message (e.g., at 224), the AIoTF 204 may stop the disable operation timer. If the timer expires prior to reception of the disable complete AIoT NAS message, and/or if transmission failure of the disable command AIoT NAS message occurs, the AIoTF 204 may abort the disable command procedure.

Each AIoT NAS message described herein may include a message type IE that indicates a message of the AIoT NAS message in which the message type IE is included. The message type IE may take different values based on which type of AIoT NAS messages are implemented. For example, when separate failure AIoT NAS messages are utilized (e.g., dedicated read failure AIoT NAS messages as described with reference to FIG. 9, dedicated write failure AIoT NAS messages as described with reference to FIG. 12), the message type IE may use the values shown in Table 1 below.

TABLE 1
Message types for AIoT NAS (option
with dedicated failure message)

| Bits | | | | | | | | |
|---|---|---|---|---|---|---|---|---|
| 8 | 7 | 6 | 5 | 4 | 3 | 2 | 1 | |
| 0 | 1 | 0 | 0 | 0 | 0 | 0 | 1 | Inventory report |
| 0 | 1 | 0 | 0 | 0 | 0 | 1 | 0 | Read command |
| 0 | 1 | 0 | 0 | 0 | 0 | 1 | 1 | Read complete |
| 0 | 1 | 0 | 0 | 0 | 1 | 0 | 0 | Read failure |
| 0 | 1 | 0 | 0 | 0 | 1 | 0 | 1 | Write command |
| 0 | 1 | 0 | 0 | 0 | 1 | 1 | 0 | Write complete |
| 0 | 1 | 0 | 0 | 0 | 1 | 1 | 1 | Write failure |
| 0 | 1 | 0 | 0 | 1 | 0 | 0 | 0 | Disable command |
| 0 | 1 | 0 | 0 | 1 | 0 | 0 | 1 | Disable complete |

Alternatively, when failure causes are indicated as part of an operation complete message (e.g., read complete AIoT NAS messages as described with reference to FIGS. 8A and 8B, write complete AIoT NAS messages as described with reference to FIGS. 11A, 11B, and 11C), the message type IE may take the values shown in Table 2 below.

TABLE 2
Message types for AIoT NAS (option with
failure cause in complete message)

| Bits | | | | | | | | |
|---|---|---|---|---|---|---|---|---|
| 8 | 7 | 6 | 5 | 4 | 3 | 2 | 1 | |
| 0 | 1 | 0 | 0 | 0 | 0 | 0 | 1 | Inventory report |
| 0 | 1 | 0 | 0 | 0 | 0 | 1 | 0 | Read command |
| 0 | 1 | 0 | 0 | 0 | 0 | 1 | 1 | Read complete |
| 0 | 1 | 0 | 0 | 0 | 1 | 0 | 0 | Write command |
| 0 | 1 | 0 | 0 | 0 | 1 | 0 | 1 | Write complete |
| 0 | 1 | 0 | 0 | 0 | 1 | 1 | 0 | Disable command |
| 0 | 1 | 0 | 0 | 0 | 1 | 1 | 1 | Disable complete |

As another example, the message type IE may utilize appropriate values in Table 1 or Table 2 when a single inventory report AIoT NAS message is implemented, such as described with reference to FIG. 5. Alternatively, when separate inventory report AIoT NAS messages are utilized for those including authentication response IEs and those excluding authentication response IEs (e.g., as described with reference to FIGS. 6A through 6C), the message type IE may take the values shown in Table 3 below.

TABLE 3
Message types for AIoT NAS (option
with two inventory report messages)

| Bits | | | | | | | | |
|---|---|---|---|---|---|---|---|---|
| 8 | 7 | 6 | 5 | 4 | 3 | 2 | 1 | |
| 0 | 1 | 0 | 0 | 0 | 0 | 0 | 1 | Inventory report |
| 0 | 1 | 0 | 0 | 0 | 0 | 1 | 0 | Inventory report with |
| | | | | | | | | authentication |
| 0 | 1 | 0 | 0 | 0 | 0 | 1 | 1 | Read command |
| 0 | 1 | 0 | 0 | 0 | 1 | 0 | 0 | Read complete |
| 0 | 1 | 0 | 0 | 0 | 1 | 0 | 1 | Read failure |
| 0 | 1 | 0 | 0 | 0 | 1 | 1 | 0 | Write command |
| 0 | 1 | 0 | 0 | 0 | 1 | 1 | 1 | Write complete |
| 0 | 1 | 0 | 0 | 1 | 0 | 0 | 0 | Write failure |
| 0 | 1 | 0 | 0 | 1 | 0 | 0 | 1 | Disable command |
| 0 | 1 | 0 | 0 | 1 | 0 | 1 | 0 | Disable complete |

Additionally, or alternatively, the security header type, the message authentication code, and the sequence number may be provided as separate IEs (e.g., as described with reference to FIGS. 15A and 17) or they may be combined into a single security header IE (e.g., as described with reference to FIGS. 15B through 15C). When providing the aforementioned in separate IEs, the security header type IE may take the values shown in Table 4 below.

TABLE 4
Security header type IE values (separate IEs)
Header type (octet 2 bits 4 to 1)

Bits

| 4 | 3 | 2 | 1 | |
|---|---|---|---|---|
| 0 | 0 | 0 | 0 | no security protection |
| 0 | 0 | 0 | 1 | integrity protected |
| 0 | 0 | 1 | 0 | integrity and confidentiality protected |

All other values are reserved.
Security header type (octet 2 bits 8 to 5)
Spare bits set to zero

When the security header IE is used, it includes the security header type, the message authentication code, and, if applicable, the sequence number. The security header IE can take the values shown in Table 5 below.

TABLE 5
Security header IE values (single IE)
Header type (octet 2 bits 4 to 1)

Bits

| 4 | 3 | 2 | 1 | |
|---|---|---|---|---|
| 0 | 0 | 0 | 0 | no security protection |
| 0 | 0 | 0 | 1 | integrity protected |
| 0 | 0 | 1 | 0 | integrity and confidentiality protected |

All other values are reserved.
Header type (octet 2 bits 4 to 1)
Spare bits set to zero
MAC (octet 3 to 6)
Message authentication code (MAC) as specified in
3GPP TS 33.369 [6].
Sequence number (octet 7) (option with SN)
AIoT NAS message sequence number (AIoT SN).

FIGS. 3 through 26 illustrate encoding and organization of the AIoT NAS protocol through message formats, contents, and IE structures. FIGS. 3 through 26 may implement or be implemented by aspects of the wireless communication system 100 as described with reference to FIGS. 1 and 2. Specifically, FIGS. 3 through 14 define content and organization of AIoT NAS messages communicated between an AIoT device and an AIoTF as described with reference to FIGS. 1 and 2, while FIGS. 15 through 26 define content and organization of AIoT NAS IEs included in such AIoT NAS messages. It should be noted that the examples of formats and contents described herein are not to be construed as limiting, and other arrangements are possible. For example, additional IEs may be added.

Within the AIoT NAS protocol described herein, every AIoT NAS message is a standard layer 3 (L3) message. Thus, each message consists of the following parts: 1). If the message is a plain AIoT NAS message (e.g., as described with reference to FIG. 3A), it includes a security header type IE, a message type IE, and other IEs as required. 2). If the message is a security protected AIoT NAS message (e.g., as described with reference to FIG. 3B), the message includes, either within a single IE (i.e., security header type IE) or across multiple IEs, the following: a security header type, a message authentication code, and/or an optional sequence number. Furthermore, the message includes a plain AIoT NAS message as defined in item 1. It should be noted that the security header type is mandatory in all AIoT NAS messages, whether the AIoT NAS message is a plain AIoT NAS message or a security protected AIoT NAS message.

FIGS. 3A and 3B illustrate examples of AIoT NAS message formats 300 and 301, respectively, in accordance with aspects of the present disclosure. Specifically, the AIoT NAS message format 300 is an example of a plain AIoT NAS message format used for unprotected AIoT NAS messages, while the AIoT NAS message format 301 is an example of a security protected AIoT NAS message format used for secure AIoT NAS messages (e.g., integrity protected or integrity and confidentiality protected AIoT NAS messages). In some examples, the AIoT NAS message format 300 may be encapsulated within the AIoT NAS message format 301. That is, a security protected AIoT NAS message may encapsulate (e.g., carry within) a plain AIoT NAS message.

The AIoT NAS message format 300 includes multiple fields (IEs) arranged in an 8-bit octet structure. The AIoT NAS message format 300 includes a security header type IE in octet 1, followed by a message type IE in octet 2. Additional IEs as required are included in octet 3 through octet n. The bits in each octet are numbered from 8 to 1. This plain message format serves as the foundation for all AIoT NAS communications shown in the signaling diagram 200 of FIG. 2. The structure enables efficient communication between AIoT devices and the AIoTF while minimizing overhead. Additional contents and organization of such are also supported, and the plain message format is not limited to the examples described herein.

In some examples, the AIoT NAS message format 300 includes or is an example of a plain AIoT NAS message IE that is included in a security protected AIoT NAS message (e.g., as described with reference to FIG. 3B). The security protected AIoT NAS message itself is not included in the plain AIoT NAS message IE.

The AIoT NAS message format 301 may be implemented for security protected AIoT NAS messages. Like the plain message format, the bits in each octet are numbered from 8 to 1. The AIoT NAS message format 301 includes a security header type field in octet 1, followed by a message authentication code field spanning octet 2 through octet a. A plain AIoT NAS message field occupies octet a+1 through octet n. This enables secure protection of any AIoT NAS message through encapsulation within a security protected AIoT NAS message.

For instance, the AIoT NAS message format 301 may include (e.g., encapsulate) the AIoT NAS message format 300 in the plain AIoT NAS message field. In such examples, the plain AIoT NAS message IE may be defined as starting from octet 2 of the plain AIoT NAS message (e.g., of the AIoT NAS message format 300), excluding the security header type IE so as to avoid redundancy in the security protected AIoT NAS message, which includes its own security header type IE. Alternatively, the plain AIoT NAS message IE includes the complete plain AIoT NAS message, starting from octet 1 (e.g., including the security header type). In this example, the security header type IE may be twice present in the security protected AIoT NAS message-once in the first octet of the plain AIoT NAS message and once in the first octet of the security protected AIoT NAS message (e.g., octet a+1 as shown in FIG. 3B).

This secure message format builds upon the basic structure shown in FIG. 3A by adding security features that protect the integrity of communications during AIoT NAS message exchanges (e.g., as shown in FIG. 2). For example, the message authentication code enables the AIoT device 202 and AIoTF 204 to protect message integrity and verify that messages have not been tampered with. Additional contents and organization of the AIoT NAS message format 301 are also supported, and this secure message format is not limited to the examples described herein. For example, the length of the message authentication code (e.g., four octets) may be modified.

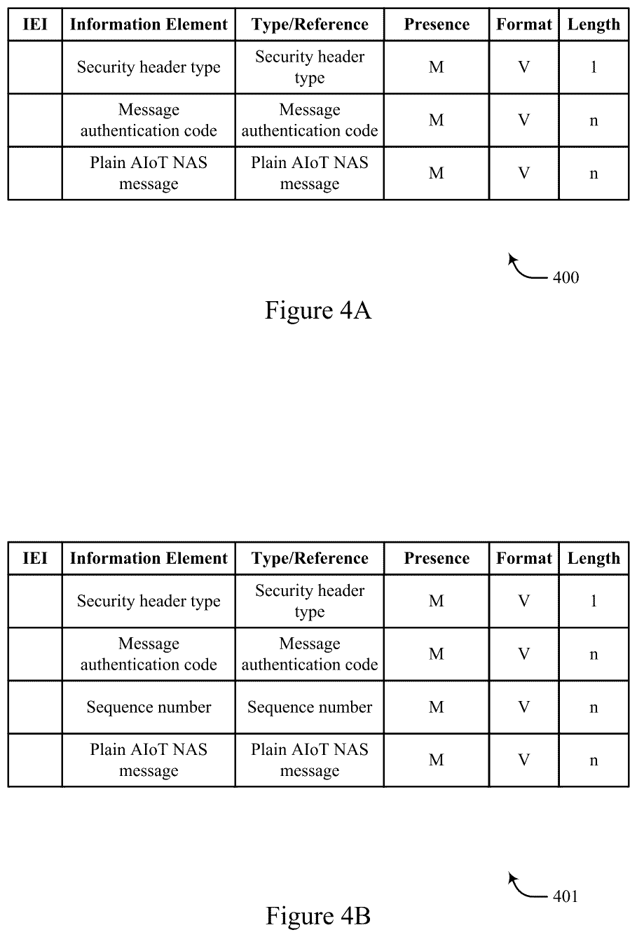

FIGS. 4A and 4B illustrate examples of security protected AIoT NAS messages 400 and 401, respectively, in accordance with aspects of the present disclosure. The security protected AIoT NAS messages 400 and 401 may be utilized by an AIoT device or an AIoTF to transfer a plain AIoT NAS message together with a message authentication code for integrity protection. The security protected AIoT NAS messages 400 and 401 may be organized according to the AIoT NAS message format illustrated in FIG. 3B.

The security protected AIoT NAS message 400 includes three IEs: a security header type, a message authentication code, and a plain AIoT NAS message. The presence column indicates that each IE is mandatory (M), while the format column indicates that each IE has a value (V) format. The length column specifies that the security header type has a length of 1 octet, while both the message authentication code and plain AIoT NAS message have a length of “n” octets. This format enables encapsulation of plain AIoT NAS messages within a security wrapper, enabling secure communication during signaling exchanges (such as those as illustrated in FIG. 2).

The security protected AIoT NAS message 401 includes four IEs: a security header type, a message authentication code, a sequence number, and a plain AIoT NAS message. Each IE has a Presence indicator of “M” and a Format indicator of “V”. The security header type has a Length of “1”, while the message authentication code, sequence number, and plain AIoT NAS message each have a Length of “n”. This enhanced security format builds upon the structure in FIG. 4A by adding a sequence number, which provides protection against replay attacks during signaling exchanges (e.g., as shown in FIG. 2). The sequence number ensures that old messages cannot be captured and replayed by an attacker, which is particularly important for operations that modify device state, such as the disable command procedure.

FIG. 5 illustrates an example of an inventory report AIoT NAS message 500 in accordance with aspects of the present disclosure. The inventory report AIoT NAS message 500 is sent by an AIoT device to an AIoTF to report the AIoT device's identity. The inventory report AIoT NAS message 500 has a message type of “inventory report,” a dual significance, and includes four IEs: a security header type, an inventory report message identity, an AIoT device identity, and an authentication response. The presence column indicates that the security header type, inventory report message identity, and AIoT device identity IEs are mandatory (M), while the authentication response IE is optional (O). The format column indicates that the security header type, inventory report message identity, and AIoT device identity IEs have value (V) formats, while the authentication response IE has a format of type-value (TV). The length column specifies that the security header type and the inventory report message identity IEs each have a length of 1 octet, while the AIoT device identity and authentication response IEs each have a length of “n” octets.

Inclusion of the optional authentication response IE enables the inventory report AIoT NAS message 500 to be utilized for both inventory request procedures and authentication procedures initiated by an AIoTF. For example, with reference to FIG. 2, the AIoT device 202 can respond to the paging message received at 206 using the inventory report AIoT NAS message 500 regardless of whether the paging message includes the random challenge. If the paging message does include the random challenge, the AIoT device 202 can include the authentication parameters in the authentication response IE of the inventory report AIoT NAS message 500. If the paging message does not include the random challenge, the AIoT device 202 can omit the authentication response IE from the inventory report AIoT NAS message 500.

FIGS. 6A through 6C illustrate examples of inventory report AIoT NAS messages 600, 601, and 602, respectively, in accordance with aspects of the present disclosure. The inventory report AIoT NAS messages 600, 601, and 602 are sent by an AIoT device to an AIoTF to report the AIoT device's identity, e.g., in response to a paging message. Specifically, the inventory report AIoT NAS messages 600 and 601 are utilized for inventory request procedures without authentication, while the inventory report AIoT NAS message 602 is utilized for authentication procedures. As described with reference to FIG. 2, the AIoT device 202 may transmit, at 208, the inventory report AIoT NAS messages 600 or 601 when the paging message received at 206 lacks a random challenge. Alternatively, if the paging message does include the random challenge, the AIoT device may transmit the inventory report AIoT NAS message 602.

The inventory report AIoT NAS messages 600 and 601 each have a message type of “inventory report” and a dual significance. The inventory report AIoT NAS message 600 includes a security header type IE, an inventory report message identity IE, and an AIoT device identity IE. The security header type, inventory report message identity, and AIoT device identity IEs are mandatory (M) and have value (V) formats. The length column specifies a length of one octet for each of the security header type and inventory report message identity IEs and n octets for the AIoT device identity IE.

The inventory report AIoT NAS message 601 includes only the message type IE and the AIoT device identity IE. Both IEs maintain the same Type/Reference fields, presence indicators (M), format indicators (V), and length values as in the inventory report AIoT NAS message 600. This format may be used in some implementations, when the inventory procedure is without security protection.

The inventory report AIoT NAS message 602 includes a security header type IE, an inventory report with authentication message identity IE, an AIoT device identity IE, and an authentication response IE. Each IE is mandatory (M) and has a value format. The security header type IE and the inventory report with authentication message identity IE each have a length of one octet, while the AIoT device identity and authentication response IEs each have a length of n octets. The inventory report AIoT NAS message 602 has a message type of “inventory report with authentication” and a dual significance.

The inventory report AIoT NAS message 602 may be an example of a dedicated authentication response message, in which the authentication response IE is mandatory rather than optional (e.g., in contrast to FIG. 5). This format is used in an inventory request procedure when authentication is required, such as when a paging message includes a random challenge. As described with reference to FIG. 2, the AIoT device 202 may send the inventory report AIoT NAS message 602 at 208 when the paging message received at 206 includes RANDAIoT_n. The AIoT device 202 derives authentication parameters including an authentication response RESAIoT and, in some cases, a device nonce (RANDAIoT_d). The AIoT device 202 includes the authentication parameter(s) in the authentication response IE.

FIGS. 7A and 7B illustrate examples of read command AIoT NAS messages 700 and 701, respectively, in accordance with aspects of the present disclosure. The read command AIoT NAS messages 700 and 701 are sent by an AIoTF to an AIoT device to retrieve data from the AIoT device's memory, e.g., as described with reference to FIG. 2. The read command AIoT NAS messages 700 and 701 each have a message type of “read command” and a dual significance.

The read command AIoT NAS message 700 includes a security header type IE, a read command message identity IE, a memory pointer IE, and a data size IE. The presence column indicates that each IE is mandatory (M). The format column indicates that each IE has a value (V) format. The length column specifies that the security header type, read command message identity, and data size IEs each have a length of 1 octet, while the memory pointer IE has a length of 2 octets.

The read command AIoT NAS message 701 includes an additional memory bank IE compared to the read command AIoT NAS message 700. Similar to the read command AIoT NAS message 700, the presence column indicates that all IEs are mandatory (M) and have a value (V) format. The length column specifies that all IEs have a length of 1 octet except for the memory pointer IE, which has a length of 2 octets. This format is used during a read command procedure when the AIoT device has multiple memory banks. The read command AIoT NAS message 701 incorporates the memory bank IE to enable the AIoTF to specify not only the address and size of the data to read but also which memory bank to access, providing improved flexibility for devices with complex memory architectures.

FIGS. 8A and 8B illustrate examples of read complete AIoT NAS messages 800 and 801, respectively, in accordance with aspects of the present disclosure. The read complete AIoT NAS messages 800 and 801 are sent by an AIoT device to an AIoTF to report the result of a read operation, e.g., as described with reference to FIG. 2. The read complete AIoT NAS messages 800 and 801 each have a message type of “read complete” and a dual significance.

The read complete AIoT NAS message 800 includes a security header type IE, a read complete message identity IE, and an AIoT data IE. The presence column indicates that each IE is mandatory (M). The format column indicates that the security header type IE and the read complete message identity IE each have a value (V) format, while the AIoT data IE has a length-value (LV) format. The length column specifies that the security header type and read complete message identity each have a length of 1 octet, while the AIoT data IE has a length of n octets. This message format is used by the AIoT device when the read operation is at least partially successful, and may implicitly or explicitly indicate as such to the AIoTF. The read complete AIoT NAS message 800 utilizes the AIoT data IE to carry the data retrieved from the AIoT device's memory back to the AIoTF. When the read operation is fully successful and the AIoT device is able to retrieve all of the requested data, the AIoT data IE length (e.g., the quantity of retrieved data octets) may be equal to the value of the data size IE indicated in the read command AIoT NAS message (e.g., as illustrated in FIGS. 7A and 7B). In partial read scenarios where the AIoT device is only able to receive a subset of the requested data, the AIoT data IE length may be equal to the quantity of octets retrieved by the AIoT device, which may be less than the value of the data size IE indicated in the read command AIoT NAS message.

The read complete AIoT NAS message 801 includes a security header type IE, a read complete message identity IE, an AIoT data IE, and a failure cause IE. The presence column indicates that each IE is mandatory (M). The format column indicates that the security header type IE, the read complete message identity IE, and the failure cause IE each have a value (V) format, while the AIoT data IE has a length-value (LV) format. The length column specifies that the security header type, the read complete message identity, and the failure cause IEs each have a length of 1 octet, while the AIoT data IE has a length of n octets. This message format is used by the AIoT device when the read operation fails, e.g., when the AIoT device is unable to retrieve the requested data. In such scenarios, the AIoT device may set the AIoT data IE length to zero.

FIG. 9 illustrates an example of a read failure AIoT NAS message 900 in accordance with aspects of the present disclosure. The read failure AIoT NAS message 900 is sent by an AIoT device to an AIoTF to report a failure cause when retrieval of requested data from the AIoT device's memory fails, e.g., during a read operation. The read failure AIoT NAS message 900 has a message type of “read failure” and a dual significance. The read failure AIoT NAS message 900 may be an example of a dedicated failure response for a read operation.

The read failure AIoT NAS message 900 includes a security header type IE, a read failure message identity IE, and a failure cause IE, which each have a mandatory (M) presence, a value (V) format, and a length of one octet.

FIGS. 10A and 10B illustrate examples of write command AIoT NAS messages 1000 and 1001, respectively, in accordance with aspects of the present disclosure. The write command AIoT NAS messages 1000 and 1001 are sent by an AIoTF to an AIoT device to store data in the AIoT device's memory, e.g., as described with reference to FIG. 2. The write command AIoT NAS messages 1000 and 1001 each have a message type of “write command” and a dual significance.

The write command AIoT NAS message 1000 includes a security header type IE, a write command message identity IE, a memory pointer IE, and an AIoT data IE. The presence column indicates that each IE is mandatory (M). The format column indicates that the security header type IE, write command message identity IE, and memory pointer IE each have a value (V) format, while the AIoT data IE has a length-value (LV) format. The length column specifies that the security header type and write command message identity IEs each have a length of one octet, the memory pointer IE has a length of 2 octets, and the AIoT data IE has a length of n octets.

The write command AIoT NAS message 1001 includes an additional memory bank IE compared to the write command AIoT NAS message 1000. Similar to the write command AIoT NAS message 1000, the presence column indicates that each IE is mandatory (M). The format column indicates that the security header type IE, write command message identity IE, memory bank IE, and memory pointer IE each have a value (V) format, while the AIoT data IE has a length-value (LV) format. The length column specifies that the security header type, memory bank, and write command message identity IEs each have a length of one octet, the memory pointer IE has a length of 2 octets, and the AIoT data IE has a length of n octets. This format is used during a write command procedure when the AIoT device has multiple memory banks. The write command AIoT NAS message 1001 incorporates the memory bank IE to enable the AIoTF to specify which memory bank to access, providing improved flexibility for devices with complex memory architectures.

FIGS. 11A, 11B, and 11C illustrate examples of write complete AIoT NAS messages 1100, 1101, and 1102, respectively, in accordance with aspects of the present disclosure. The write complete AIoT NAS messages 1100, 1101, and 1102 are sent by an AIoT device to an AIoTF to report the result of a write operation, e.g., as described with reference to FIG. 2. The write complete AIoT NAS messages 1100, 1101, and 1102 each have a message type of “write complete” and a dual significance.

The write complete AIoT NAS message 1100 includes a security header type IE and a write complete message identity IE. The presence column indicates that each IE is mandatory (M). The format column indicates that each IE has a value (V) format, while the length column specifies that each IE has a length of 1 octet. This message format is used by the AIoT device when the read operation is fully successful (e.g., when all indicated data octets are successfully written to the AIoT device's memory), and may implicitly or explicitly indicate as such to the AIoTF (e.g., via exclusion of a data size IE).

The write complete AIoT NAS message 1101 includes a security header type IE, a write complete message identity IE, and a data size IE. The presence column indicates that each IE is mandatory (M). The format column indicates that each IE has a value (V) format, while the length column specifies that each IE has a length of 1 octet. This message format is used by the AIoT device when the read operation is partially successful (e.g., when a subset of the indicated data octets are successfully written to the AIoT device's memory), and may implicitly or explicitly indicate as such to the AIoTF. The data size IE indicates the quantity of octets successfully written to memory by the AIoT device, which may be less than the length of the AIoT data IE indicated in the write command AIoT NAS message.

The write complete AIoT NAS message 1102 includes a security header type IE, a write complete message identity IE, and a failure cause IE. The presence column indicates that each IE is mandatory (M). The format column indicates that each IE has a value (V) format, while the length column specifies that each IE has a length of 1 octet. This message format is used by the AIoT device when the write operation fails (e.g., when the AIoT device is unable to store the indicated data) to indicate the reason for failure to the AIoTF.

FIG. 12 illustrates an example of a write failure AIoT NAS message 1200 in accordance with aspects of the present disclosure. The write failure AIoT NAS message 1200 is sent by an AIoT device to an AIoTF when storage of data in the AIoT device's memory fails, e.g., during a write operation. The write failure AIoT NAS message 1200 has a message type of “write failure” and a dual significance. The write failure AIoT NAS message 1200 may be an example of a dedicated failure response for a write operation.

The write failure AIoT NAS message 1200 includes a security header type IE, a write failure message identity IE, and a failure cause IE, which each have a mandatory (M) presence, a value (V) format, and a length of one octet.

FIGS. 13A and 13B illustrate examples of disable command AIoT NAS messages 1300 and 1301, respectively, in accordance with aspects of the present disclosure. The disable command AIoT NAS messages 1300 and 1301 are sent by an AIoTF to an AIoT device to stop the AIoT device from responding to inventory requests and from generating modulation signals, e.g., as described with reference to FIG. 2. The disable command AIoT NAS messages 1300 and 1301 each have a message type of “disable command” and a dual significance.

The disable command AIoT NAS message 1300 includes a security header type IE and a disable command message identity IE, which are each mandatory (M), have a value (V) format, and have a length of one octet.

The disable command AIoT NAS message 1301 may be utilized to indicate activation criteria according to which the AIoT device is to resume operations after being disabled. The disable command AIoT NAS message 1301 includes a security header type IE, a disable command message identity IE, and an activation criteria IE, which are each mandatory (M) and have a value (V) format. The security header type IE and disable command message identity IE each have a length of one octet, while the activation criteria IE has a length of n octets. The activation criteria IE indicates the activation criteria.

FIG. 14 illustrates an example of disable complete AIoT NAS message 1400 in accordance with aspects of the present disclosure. The disable complete AIoT NAS message 1400 is sent by an AIoT device to an AIoTF to report successful disablement of the AIoT device, e.g., as described with reference to FIG. 2. The disable complete AIoT NAS message 1400 has a message type of “disable complete” and a dual significance.

The disable complete AIoT NAS message 1400 includes a security header type IE and a disable complete message identity IE, which are each mandatory (M), have a value (V) format, and have a length of one octet.

FIGS. 15A, 15B, and 15C illustrate examples of security header formats 1500, 1501, and 1502, respectively, in accordance with aspects of the present disclosure. Specifically, the security header format 1500 illustrates an example in which the security header type is a separate IE, while the security header formats 1501 and 1502 illustrate examples in which the security header type, the message authentication code, and the sequence number (in the case of the security header format 1502) are combined into a same IE. Each of the security header formats 1500, 1501, and 1502 may be understood as security headers (e.g., security header IEs) for an AIoT NAS message as described herein. The security header 1500 may also be referred to (e.g., interchangeably) as a security header type IE. That is, the security header format 1500 may be considered a security header and/or a security header type IE.

As described herein, a security header type (e.g., an indication of a security header type) is mandatory to be included in every AIoT NAS message, such as those described with reference to FIGS. 2 through 14. The security header type includes control information related to the security protection of the AIoT NAS message in which it is included. The security header type IE illustrated by the security header format 1500 is a type 3 IE. The security header IEs illustrated by the illustrated by the security header formats 1501 and 1502 are each type 3 IEs. The fields included in each security header format may indicate (e.g., implicitly or explicitly) whether the corresponding AIoT NAS message is unprotected, integrity protected, or integrity and confidentiality protected.

The security header type IE illustrated by the security header format 1500 may be utilized for AIoT NAS messages without security protection. For example, a device (e.g., an AIoT device, an AIoTF) receiving an AIoT NAS message with a security header including only the security header type IE may determine, based on the security header (e.g., the security header type IE) lacking a message authentication code, that the AIoT NAS message is unprotected. The security header type IE includes three octets. The first octet includes a security header IE identifier (IEI), while the second octet includes a length of security header contents. Octet 3 contains spare bits (bits 8-5 set to 0) and a header type field (bits 4-1).

The security header IE illustrated by the security header format 1501 may be utilized for AIoT NAS messages that are integrity protected or integrity and confidentiality protected. For example, a device (e.g., an AIoT device, an AIoTF) receiving an AIoT NAS message with a security header including the security header IE as shown in the security header format 1501 may determine, based on the security header IE including a security header type and a message authentication code, that the AIoT NAS message is integrity protected. This security header IE includes six octets. The first octet includes a security header IEI, while the second octet contains spare bits (bits 8-5 set to 0) and a security header type field (bits 4-1). The security header IE also includes a message authentication code field spanning octet 3 through octet 6. The inclusion of the message authentication code enables verification of message integrity.

The security header IE illustrated by the security header format 1502 may be utilized for AIoT NAS messages that are integrity protected or integrity and confidentiality protected and that include a sequence number for replay protection. This security header IE includes seven octets. The first octet includes a security header IEI, while the second octet contains spare bits (bits 8-5 set to 0) and a security header type field (bits 4-1). The security header IE also includes a message authentication code field spanning octet 3 through octet 6 and a sequence number field in octet 7. The sequence number can be used in conjunction with the message authentication code to ensure the freshness and ordering of AIoT NAS messages, further improving security.

The security header formats 1501 and 1502 each illustrate a message authentication code with a length of four octets. In some implementations, a message authentication code with a length of two octets may be used instead.

FIGS. 16A and 16B illustrate examples of authentication response IEs 1600 and 1601, respectively, in accordance with aspects of the present disclosure. An authentication response IE provides authentication response information from an AIoT device. For instance, an AIoT device may include authentication parameters in the authentication response IE in an inventory report message initiated in response to an authentication procedure and/or a paging message received from an AIoTF, as described with reference to FIGS. 2, 5, and 6C. The authentication response IE is a type 3 IE (when it excludes a length indicator, as shown in FIG. 16A) or a type 4 IE (when it includes a length indicator, as shown in FIG. 16B).

The authentication response IE 1600 includes an authentication response IEI field in the first octet. Octets 2 through a contain a RES_{AIoT} field. Octets a+1 through octet b contains the RAND_{AIoT_d} field. The authentication response IE 1601 includes the authentication response IEI, RES_{AIoT} field, and RAND_{AIoT_d} field, along with an additional field for a length of the authentication response. The authentication response IEs 1600 and 1601 can take the values shown in Table 6 below.

TABLE 6
Authentication response

Authentication response contents (octets 2 to b) or (octets 3 to b Option
with length field)
RES_{AIoT} (octet 2 to a) or octets 3 to a (Option with length field)
RES_{AIoT} is coded as specified in 3GPP TS 33.369 [6].
RAND_{AIOT}_{_{—}}_{d} (octets a + 1 to b)
RAND_{AIOT}_{_{—}}_{d} is coded as specified in 3GPP TS 33.369 [6].

FIG. 17 illustrates an example of a message authentication code IE 1700 in accordance with aspects of the present disclosure. The message authentication code IE 1700 contains integrity protection information for the AIoT NAS message in which it is included. The message authentication code IE 1700 is included in security protected AIoT messages, e.g., as described with reference to FIGS. 2 through 14. The message authentication code IE 1700 is a type 3 IE that includes a message authentication code IEI in a first octet and a message authentication code value in subsequent octets.

FIG. 18 illustrates an example of a memory bank IE 1800 in accordance with aspects of the present disclosure. The memory bank IE 1800 indicates a memory bank of an AIoT device to be used for data storage and retrieval. For instance, the memory bank IE 1800 may be included in a read command AIoT NAS message as described with reference to FIG. 7B and/or a write command AIoT NAS message as described with reference to FIG. 10B. The memory bank IE 1800 is a type 3 IE with a length of two octets. The memory bank IE 1800 includes a memory bank IEI in octet 1 and a memory bank value in octet 2, and can take the values shown in Table 7 below.

TABLE 7
Memory bank
Memory bank value (octet 2, bits 1 to 3)

| Bits | | | |
|---|---|---|---|
| 3 | 2 | 1 | |
| 0 | 0 | 0 | Reserved memory |
| 0 | 0 | 1 | EPC memory |
| 0 | 1 | 0 | TID memory |
| 0 | 1 | 1 | User memory |

All other values are spare. If received, they shall be ignored.

FIG. 19 illustrates an example of a memory pointer IE 1900 in accordance with aspects of the present disclosure. The memory pointer IE 1900 indicates an address (e.g., a start address) within a memory of an AIoT device to be used for data storage and retrieval. For instance, the memory pointer IE 1900 may be included in a read command AIoT NAS message as described with reference to FIGS. 7A and 7B and/or a write command AIoT NAS message as described with reference to FIGS. 10A and 10B. The memory pointer IE 1900 is a type 3 IE with a length of three octets. The memory pointer IE 1900 includes a memory pointer IEI in octet 1 and a memory pointer value in octets 2 and 3, and can take the values shown in Table 8 below.

TABLE 8
Memory pointer

Memory pointer value (octets 3 to 4)
Memory pointer contains the binary encoding of an address within the
memory at the AIoT device.

FIG. 20 illustrates an example of a data size IE 2000 in accordance with aspects of the present disclosure. The data size IE 2000 indicates a quantity of octets to be retrieved from an AIoT device's memory. For instance, the data size IE 2000 may be included in a read command AIoT NAS message as described with reference to FIGS. 7A and 7B and/or a write complete AIoT NAS message as described with reference to FIG. 11B. The data size IE 2000 is a type 3 IE with a length of two octets. The data size IE 2000 includes a data size IEI in octet 1 and a data size value in octets 2 and 3, and can take the values shown in Table 9 below.

TABLE 9
Data size

Data size value (octet 2)
Data size contains the binary encoding of the number of data octets.

FIG. 21 illustrates an example of an AIoT data IE 2100 in accordance with aspects of the present disclosure. The AIoT data IE 2100 provides (e.g., indicates) data octets to be stored at an AIoT device's memory, e.g., when included in a write command AIoT NAS message as described with reference to FIGS. 10A and 10B. Additionally, the AIoT data IE 2100 indicates data octets retrieved from memory by the AIoT device, e.g., when included in a read complete AIoT NAS message as described with reference to FIG. 8A. The AIoT data IE 2100 is a type 4 IE and includes an AIoT data IEI in octet 1, an AIoT data length in octet 2, and AIoT data contents in subsequent octets. The AIoT data IE 2100 can take the values shown in Table 10 below.

TABLE 10
AIoT data

AIoT data contents (octets 3 to a)
AIoT data contents contains data octets.

FIG. 22 illustrates an example of a failure cause IL 2200 in accordance with aspects of the present disclosure. The failure cause IL 2200 is utilized by an AoT device to indicate an error code to an AIoTF upon read and write operation failure. For instance, the failure cause IL 2200 may be included in a read complete AoT NAS message as described with reference to FIGS. 8B and 9, and/or in a write complete AIoT NAS message as described with reference to FIGS. 11C and 12. The failure cause IL 2200 is a type 3 IE with a length of two octets, and includes a failure cause JET in octet 1 and a failure cause value in octet 2. The failure cause IL 2200 can take the values shown in Table 11 below.

TABLE 11
Failure cause

| Failure cause (octet 2) | | | | | | | | |
|---|---|---|---|---|---|---|---|---|
| 8 | 7 | 6 | 5 | 4 | 3 | 2 | 1 | |
| 0 | 0 | 0 | 0 | 0 | 0 | 0 | 0 | Other error. |
| 0 | 0 | 0 | 0 | 0 | 0 | 0 | 1 | Not supported. The AIoT device does not support the |
| | | | | | | | | specified parameters or feature. |
| 0 | 0 | 0 | 0 | 0 | 0 | 1 | 0 | Reserved. |
| 0 | 0 | 0 | 0 | 0 | 0 | 1 | 1 | Memory overrun. The AIoT device memory location does |
| | | | | | | | | not exist, is too small, or the AIoT device does not support |
| | | | | | | | | the specified EPC length |
| 0 | 0 | 0 | 0 | 0 | 1 | 0 | 0 | Memory locked. The Tag memory location is locked or |
| | | | | | | | | permalocked and is either not writeable or not readable. |
| 0 | 0 | 0 | 0 | 0 | 1 | 0 | 1 | Reserved. |
| 0 | 0 | 0 | 0 | 0 | 1 | 1 | 0 | Reserved. |
| 0 | 0 | 0 | 0 | 0 | 1 | 1 | 1 | Reserved. |
| 0 | 0 | 0 | 0 | 1 | 0 | 0 | 0 | Reserved. |
| 0 | 0 | 0 | 0 | 1 | 0 | 1 | 1 | Insufficient power. The AIoT device has insufficient power |
| | | | | | | | | to perform the operation. |
| 0 | 0 | 0 | 0 | 1 | 1 | 1 | 1 | Unspecified. |

The receiving entity shall treat any other value as 0000 1111, “Unspecified”.

FIG. 23 illustrates an example of an activation criteria IL 2300 in accordance with aspects of the present disclosure. The activation criteria IL 2300 specifies activation criteria for an AIoT device to resume operation after being disabled. For example, the activation criteria IL 2300 may be included in a disable command AIoT NAS message as described with reference to FIG. 13B. The AIoT device may monitor the activation criteria to detect whether one or more indicated conditions are satisfied. When a satisfied condition is detected, the AIoT device may resume operations.

The activation criteria IE 2300 includes an activation criteria IEI, a length field, and the following information: Environmental conditions (e.g., threshold information for temperature, humidity, pressure, light levels, air quality, noise levels, motion, etc.); time conditions (time window information); location information (geographical information, reader service areas); anomaly detection and alerts (e.g., real-time analysis of combined events, such as a temperature spike in a cold chain scenario).

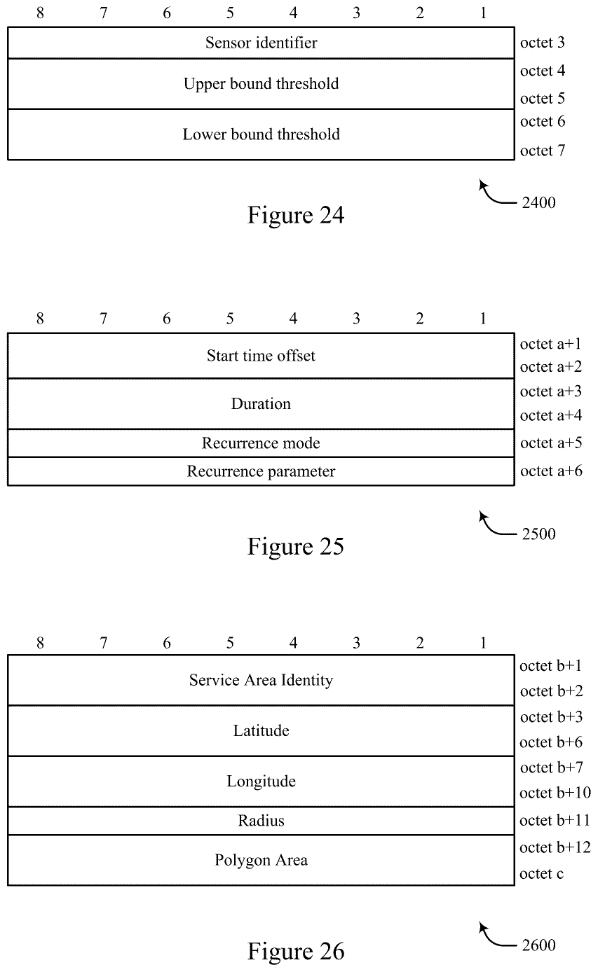

FIGS. 24, 25, and 26 illustrate an environmental conditions IE 2400, a time conditions IE 2500, and a location IE 2600, respectively, in accordance with aspects of the present disclosure. One or more of the environmental conditions IE 2400, the time conditions IE 2500, and the location IE 2600 may be included in the activation criteria IE 2300. The environmental conditions IE 2400 may indicate a sensor identifier for a sensor of the AIoT device, used to monitor a corresponding environmental condition as defined by an upper bound threshold and/or a lower bound threshold also indicated in the environmental conditions IE 2400. The time conditions IE 2500 may indicate a start time offset (e.g., relative to reception of the activation criteria IE 2300 at the AIoT device), a time duration, a recurrence mode, and/or a recurrence parameter. The location IE 2600 may indicate one or more of a service area identity, a latitude, a longitude, a radius, or a polygon area. The activation criteria IE 2300, including the environmental conditions IE 2400, the time conditions IE 2500, and the location IE 2600, may take the values shown in Table 12 below.

TABLE 12
Activation criteria

Activation criteria contents (octet 3 to octet d)
Environmental conditions (octet 3 to octet a)
Sensor Identifier (octet 3): The sensor identifier in binary encoding
Upper bound threshold (octets 4 to 5): The upper bound threshold in binary encoding
Lower bound threshold (octets 6 to 7): The lower bound threshold in binary encoding
Time conditions (octet a + 1 to octet b)
Start time offset (octets a + 1 to a + 2): Offset in minutes from midnight UTC time in binary
encoding.
Duration (octets a + 3 to a + 4): Duration in minutes in binary encoding.
Recurrence mode (octets a + 5)
00000000: One-time
00000001: Daily
00000010: Weekly
00000011: Monthly
Recurrence parameter (octets a + 6)
In case of weekly recurrence, the day of the week in binary coding (Monday: 1,
Tuesday: 2, . . . , Sunday: 7);
In case of Monthly recurrence, the day of the month in binary coding (1, . . . , 31).
Location (octets b + 1 to c)
Service Area Identity (octets b + 1 to b + 2): The service area identity in binary encoding.
Latitude (octets b + 3 to b + 6): The latitude encoded as signed 32-bit fixed-point with 1e−6
degree resolution.
Longitude (octets b + 7 to b + 10): The longitude encoded as signed 32-bit fixed-point with
1e−6 degree resolution.
Radius (octet b + 11): The radius in meters in binary encoding
Polygon Area (octets b + 12 to c): Vertex list with N × 8 octets (4 for lat, 4 for lon)
Anomaly detection and alerts identifier (octets c + 1 octet c + 2): The anomaly detection and
alerts identifier in binary encoding

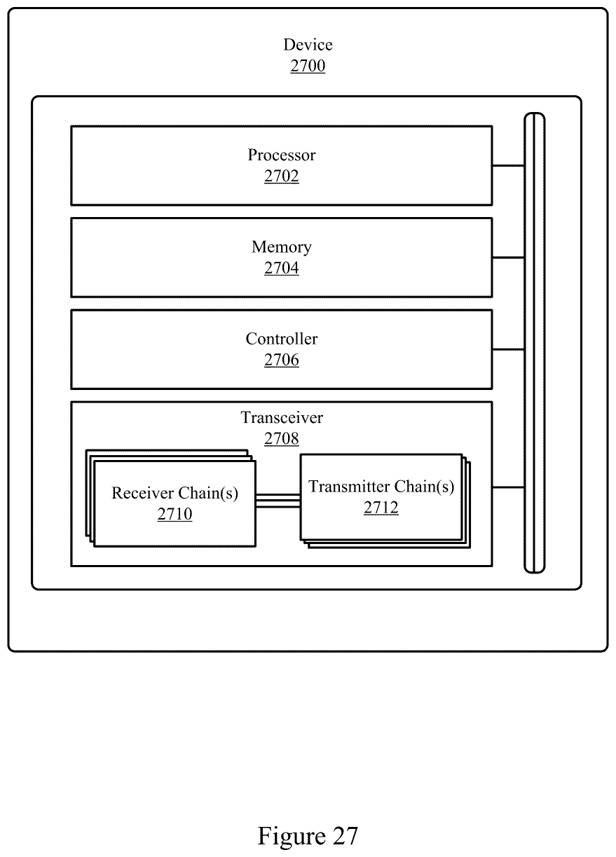

FIG. 27 illustrates an example of a device 2700 in accordance with aspects of the present disclosure. The device 2700 may include a processor 2702, a memory 2704, a controller 2706, and a transceiver 2708. The processor 2702, the memory 2704, the controller 2706, or the transceiver 2708, or various combinations thereof or various components thereof may be examples of means for performing various aspects of the present disclosure as described herein. These components may be coupled (e.g., operatively, communicatively, functionally, electronically, electrically) via one or more interfaces. The device 2700 may be a low power device (e.g., an AIoT device), a UE, or so forth.

The processor 2702, the memory 2704, the controller 2706, or the transceiver 2708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 2702 may include an intelligent hardware device (e.g., a general-purpose processor, a DSP, a central processing unit (CPU), an ASIC, a field-programmable gate-array (FPGA), or any combination thereof). In some implementations, the processor 2702 may be configured to operate the memory 2704. In some other implementations, the memory 2704 may be integrated into the processor 2702. The processor 2702 may be configured to execute computer-readable instructions stored in the memory 2704 to cause the device 2700 to perform various functions of the present disclosure.

The memory 2704 may include volatile or non-volatile memory. The memory 2704 may store computer-readable, computer-executable code including instructions when executed by the processor 2702 cause the device 2700 to perform various functions described herein. The code may be stored in a non-transitory computer-readable medium such as the memory 2704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 2702 and the memory 2704 coupled with the processor 2702 may be configured to cause the device 2700 to perform one or more of the functions described herein (e.g., executing, by the processor 2702, instructions stored in the memory 2704). For example, the processor 2702 may support wireless communication at the device 2700 in accordance with examples as disclosed herein. The device 2700 may be configured to or operable to support a means for receiving a first AIoT NAS message that includes a security header type, a message authentication code, and a message type; and transmitting, in response to the first AIoT NAS message, a second AIoT NAS message that includes the security header type, the message authentication code, and the message type.

Additionally, the device 2700 may be configured to support any one or combination of the first AIoT NAS message is a read command NAS message that includes a memory pointer IE that indicates a start address within the at least one memory and a data size IE that indicates a first quantity of octets of data to be retrieved from the at least one memory, and initiating, in response to the read command NAS message, a read operation to retrieve the data from the at least one memory according to the memory pointer IE and the data size IE; the second AIoT NAS message indicates a failure cause based on a failure result of the read operation; the retrieved data includes a second quantity of octets that is less than the first quantity of octets indicated by the data size IE, and the second AIoT NAS message is a read complete NAS message that includes an AIoT data IE with an AIoT data length equal to the second quantity of octets; receiving a subsequent read command NAS message that indicates, based on the second quantity of octets, an updated memory pointer IE and an updated data size IE, initiating a subsequent read operation according to the updated memory pointer IE and the updated data size IE, and transmitting a subsequent AIoT NAS message that indicates a result of the subsequent read operation; the first AIoT NAS message is a write command NAS message that includes a memory pointer IE that indicates a start address within the at least one memory and an AIoT data IE that indicates data to be stored in the at least one memory, and initiating, in response to the first AIoT NAS message, a write operation to store the data in the at least one memory according to the memory pointer IE and the AIoT data IE; the second AIoT NAS message indicates a failure cause based on a failure result of the write operation; the second AIoT NAS message is a write complete NAS message that indicates a successful result of the write operation; the AIoT data IE further indicates a first quantity of octets of the data, the stored data includes a second quantity of octets that is less than the first quantity of octets indicated by the AIoT data IE, and the second AIoT NAS message is a write complete NAS message that includes a data size IE that indicates the second quantity of octets; receiving a subsequent write command NAS message that indicates, based on the second quantity of octets, an updated memory pointer IE and an updated AIoT data IE, initiating a subsequent write operation according to the updated memory pointer IE and the updated AIoT data IE, and transmitting a subsequent AIoT NAS message that indicates a result of the subsequent write operation; the first AIoT NAS message is a disable command NAS message, the second AIoT NAS message is a disable complete NAS message, and disabling, subsequent to transmitting the disable complete NAS message, generation of modulation signals, and disabling, subsequent to transmitting the disable complete NAS message, transmission of responses to inventory request messages; the disable command NAS message indicates one or more activation criteria for resuming operation of the device, and monitoring one or more conditions corresponding to the one or more activation criteria, and in response to determining, based on the monitoring, that at least one activation criterion of the one or more activation criteria is met, resuming generation of modulation signals and transmission of responses to inventory request messages; at least one of the first AIoT NAS message and the second AIoT NAS message is an unprotected AIoT NAS message encapsulated in a security protected AIoT NAS message, and the security protected AIoT NAS message includes, in one or more IEs, the security header type and the message authentication code; the security header includes, in one or more IEs, at least one of an indication of a security status of a corresponding AIoT NAS message, the message authentication code, or a sequence number; the security header type is carried in an initial octet of a corresponding AIoT NAS message and indicates a security status of the corresponding AIoT NAS message; verifying integrity of the first AIoT NAS message using the message authentication code; transmitting an AIoT inventory report NAS message that includes at least one of the security header, an AIoT device identity of the device, a random challenge, or an authentication response parameter; the AIoT inventory report NAS message is a dedicated authentication procedure response NAS message, and the random challenge and the authentication response parameter are carried in an authentication response IE.

Additionally, or alternatively, the device 2700 may support at least one memory (e.g., the memory 2704) and at least one processor (e.g., the processor 2702) coupled with the at least one memory and configured to cause the device 2700 to receive a first AIoT NAS message that includes a security header type, a message authentication code, and a message type; and transmit, in response to the first AIoT NAS message, a second AIoT NAS message that includes the security header type, the message authentication code, and the message type.

Additionally, the device 2700 may be configured to support any one or combination of the first AIoT NAS message is a read command NAS message that includes a memory pointer IE that indicates a start address within the at least one memory and a data size IE that indicates a first quantity of octets of data to be retrieved from the at least one memory, and initiate, in response to the read command NAS message, a read operation to retrieve the data from the at least one memory according to the memory pointer IE and the data size IE; the second AIoT NAS message indicates a failure cause based on a failure result of the read operation; the retrieved data includes a second quantity of octets that is less than the first quantity of octets indicated by the data size IE, and the second AIoT NAS message is a read complete NAS message that includes an AIoT data IE with an AIoT data length equal to the second quantity of octets; receive a subsequent read command NAS message that indicates, based on the second quantity of octets, an updated memory pointer IE and an updated data size IE, initiate a subsequent read operation according to the updated memory pointer IE and the updated data size IE, and transmit a subsequent AIoT NAS message that indicates a result of the subsequent read operation; the first AIoT NAS message is a write command NAS message that includes a memory pointer IE that indicates a start address within the at least one memory and an AIoT data IE that indicates data to be stored in the at least one memory, and initiate, in response to the first AIoT NAS message, a write operation to store the data in the at least one memory according to the memory pointer IE and the AIoT data IE; the second AIoT NAS message indicates a failure cause based on a failure result of the write operation; the second AIoT NAS message is a write complete NAS message that indicates a successful result of the write operation; the AIoT data IE further indicates a first quantity of octets of the data, the stored data includes a second quantity of octets that is less than the first quantity of octets indicated by the AIoT data IE, and the second AIoT NAS message is a write complete NAS message that includes a data size IE that indicates the second quantity of octets; receive a subsequent write command NAS message that indicates, based on the second quantity of octets, an updated memory pointer IE and an updated AIoT data IE, initiate a subsequent write operation according to the updated memory pointer IE and the updated AIoT data IE, and transmit a subsequent AIoT NAS message that indicates a result of the subsequent write operation; the first AIoT NAS message is a disable command NAS message, the second AIoT NAS message is a disable complete NAS message, and disable, subsequent to transmitting the disable complete NAS message, generation of modulation signals, and disable, subsequent to transmitting the disable complete NAS message, transmission of responses to inventory request messages; the disable command NAS message indicates one or more activation criteria for resuming operation of the device, and monitor one or more conditions corresponding to the one or more activation criteria, and in response to determining, based on the monitoring, that at least one activation criterion of the one or more activation criteria is met, resume generation of modulation signals and transmission of responses to inventory request messages; at least one of the first AIoT NAS message and the second AIoT NAS message is an unprotected AIoT NAS message encapsulated in a security protected AIoT NAS message, and the security protected AIoT NAS message includes, in one or more IEs, the security header type, and the message authentication code; the security header includes, in one or more IEs, at least one of an indication of a security status of a corresponding AIoT NAS message, the message authentication code, or a sequence number; the security header type is carried in an initial octet of a corresponding AIoT NAS message and indicates a security status of the corresponding AIoT NAS message; verify integrity of the first AIoT NAS message using the message authentication code; transmit an AIoT inventory report NAS message that includes at least one of the security header, an AIoT device identity of the device, a random challenge, or an authentication response parameter; the AIoT inventory report NAS message is a dedicated authentication procedure response NAS message, and the random challenge and the authentication response parameter are carried in an authentication response IE.

The controller 2706 may manage input and output signals for the device 2700. The controller 2706 may also manage peripherals not integrated into the device 2700. In some implementations, the controller 2706 may utilize an operating system such as iOS®, ANDROID®, WINDOWS®, or other operating systems. In some implementations, the controller 2706 may be implemented as part of the processor 2702.

In some implementations, the device 2700 may include at least one transceiver 2708. In some other implementations, the device 2700 may have more than one transceiver 2708. The transceiver 2708 may represent a wireless transceiver. The transceiver 2708 may include one or more receiver chains 2710, one or more transmitter chains 2712, or a combination thereof.

A receiver chain 2710 may be configured to receive signals (e.g., control information, data, packets) over a wireless medium. For example, the receiver chain 2710 may include one or more antennas to receive a signal over the air or wireless medium. The receiver chain 2710 may include at least one amplifier (e.g., a low-noise amplifier (LNA)) configured to amplify the received signal. The receiver chain 2710 may include at least one demodulator configured to demodulate the receive signal and obtain the transmitted data by reversing the modulation technique applied during transmission of the signal. The receiver chain 2710 may include at least one decoder for decoding the demodulated signal to receive the transmitted data.

A transmitter chain 2712 may be configured to generate and transmit signals (e.g., control information, data, packets). The transmitter chain 2712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 2712 may also include at least one power amplifier configured to amplify the modulated signal to an appropriate power level suitable for transmission over the wireless medium. The transmitter chain 2712 may also include one or more antennas for transmitting the amplified signal into the air or wireless medium.

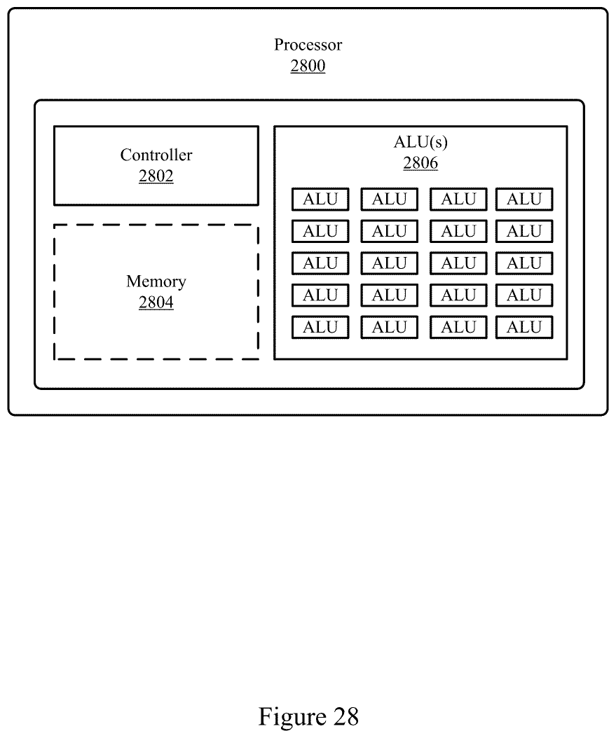

FIG. 28 illustrates an example of a processor 2800 in accordance with aspects of the present disclosure. The processor 2800 may be an example of a processor configured to perform various operations in accordance with examples as described herein. The processor 2800 may include a controller 2802 configured to perform various operations in accordance with examples as described herein. The processor 2800 may optionally include at least one memory 2804, which may be, for example, an L1/L2/L3 cache. Additionally, or alternatively, the processor 2800 may optionally include one or more arithmetic-logic units (ALUs) 2806. One or more of these components may be in electronic communication or otherwise coupled (e.g., operatively, communicatively, functionally, electronically, electrically) via one or more interfaces (e.g., buses).

The processor 2800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 2800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 2802 may be configured to manage and coordinate various operations (e.g., signaling, receiving, obtaining, retrieving, transmitting, outputting, forwarding, storing, determining, identifying, accessing, writing, reading) of the processor 2800 to cause the processor 2800 to support various operations in accordance with examples as described herein. For example, the controller 2802 may operate as a control unit of the processor 2800, generating control signals that manage the operation of various components of the processor 2800. These control signals include enabling or disabling functional units, selecting data paths, initiating memory access, and coordinating timing of operations.

The controller 2802 may be configured to fetch (e.g., obtain, retrieve, receive) instructions from the memory 2804 and determine subsequent instruction(s) to be executed to cause the processor 2800 to support various operations in accordance with examples as described herein. The controller 2802 may be configured to track memory addresses of instructions associated with the memory 2804. The controller 2802 may be configured to decode instructions to determine the operation to be performed and the operands involved. For example, the controller 2802 may be configured to interpret the instruction and determine control signals to be output to other components of the processor 2800 to cause the processor 2800 to support various operations in accordance with examples as described herein. Additionally, or alternatively, the controller 2802 may be configured to manage flow of data within the processor 2800. The controller 2802 may be configured to control transfer of data between registers, ALUs 2806, and other functional units of the processor 2800.

The memory 2804 may include one or more caches (e.g., memory local to or included in the processor 2800 or other memory, such as RAM, ROM, DRAM, SDRAM, SRAM, MRAM, flash memory, etc. In some implementations, the memory 2804 may reside within or on a processor chipset (e.g., local to the processor 2800). In some other implementations, the memory 2804 may reside external to the processor chipset (e.g., remote to the processor 2800).

The memory 2804 may store computer-readable, computer-executable code including instructions that, when executed by the processor 2800, cause the processor 2800 to perform various functions described herein. The code may be stored in a non-transitory computer-readable medium such as system memory or another type of memory. The controller 2802 and/or the processor 2800 may be configured to execute computer-readable instructions stored in the memory 2804 to cause the processor 2800 to perform various functions. For example, the processor 2800 and/or the controller 2802 may be coupled with or to the memory 2804, the processor 2800, and the controller 2802, and may be configured to perform various functions described herein. In some examples, the processor 2800 may include multiple processors and the memory 2804 may include multiple memories. One or more of the multiple processors may be coupled with one or more of the multiple memories, which may, individually or collectively, be configured to perform various functions herein.

The one or more ALUs 2806 may be configured to support various operations in accordance with examples as described herein. In some implementations, the one or more ALUs 2806 may reside within or on a processor chipset (e.g., the processor 2800). In some other implementations, the one or more ALUs 2806 may reside external to the processor chipset (e.g., the processor 2800). One or more ALUs 2806 may perform one or more computations such as addition, subtraction, multiplication, and division on data. For example, one or more ALUs 2806 may receive input operands and an operation code, which determines an operation to be executed. One or more ALUs 2806 may be configured with a variety of logical and arithmetic circuits, including adders, subtractors, shifters, and logic gates, to process and manipulate the data according to the operation. Additionally, or alternatively, the one or more ALUs 2806 may support logical operations such as AND, OR, exclusive-OR (XOR), not-OR (NOR), and not-AND (NAND), enabling the one or more ALUs 2806 to handle conditional operations, comparisons, and bitwise operations.

The processor 2800 may support wireless communication in accordance with examples as disclosed herein. The processor 2800 may be configured to or operable to support at least one controller (e.g., the controller 2802) coupled with at least one memory (e.g., the memory 2804) and configured to cause the processor to receive a first AIoT NAS message that includes a security header, a message authentication code, and a message type; and transmit, in response to the first AIoT NAS message, a second AIoT NAS message that includes the security header, the message authentication code, and the message type.

Additionally, the processor 2800 may be configured to or operable to support any one or combination of the first AIoT NAS message is a read command NAS message that includes a memory pointer IE that indicates a start address within the at least one memory and a data size IE that indicates a first quantity of octets of data to be retrieved from the at least one memory, and initiate, in response to the read command NAS message, a read operation to retrieve the data from the at least one memory according to the memory pointer IE and the data size IE; the second AIoT NAS message indicates a failure cause based on a failure result of the read operation; the retrieved data includes a second quantity of octets that is less than the first quantity of octets indicated by the data size IE, and the second AIoT NAS message is a read complete NAS message that includes an AIoT data IE with an AIoT data length equal to the second quantity of octets; receive a subsequent read command NAS message that indicates, based on the second quantity of octets, an updated memory pointer IE and an updated data size IE, initiate a subsequent read operation according to the updated memory pointer IE and the updated data size IE, and transmit a subsequent AIoT NAS message that indicates a result of the subsequent read operation; the first AIoT NAS message is a write command NAS message that includes a memory pointer IE that indicates a start address within the at least one memory and an AIoT data IE that indicates data to be stored in the at least one memory, and initiate, in response to the first AIoT NAS message, a write operation to store the data in the at least one memory according to the memory pointer IE and the AIoT data IE; the second AIoT NAS message indicates a failure cause based on a failure result of the write operation; the second AIoT NAS message is a write complete NAS message that indicates a successful result of the write operation; the AIoT data IE further indicates a first quantity of octets of the data, the stored data includes a second quantity of octets that is less than the first quantity of octets indicated by the AIoT data IE, and the second AIoT NAS message is a write complete NAS message that includes a data size IE that indicates the second quantity of octets; receive a subsequent write command NAS message that indicates, based on the second quantity of octets, an updated memory pointer IE and an updated AIoT data IE, initiate a subsequent write operation according to the updated memory pointer IE and the updated AIoT data IE, and transmit a subsequent AIoT NAS message that indicates a result of the subsequent write operation; the first AIoT NAS message is a disable command NAS message, the second AIoT NAS message is a disable complete NAS message, and disable, subsequent to transmitting the disable complete NAS message, generation of modulation signals, and disable, subsequent to transmitting the disable complete NAS message, transmission of responses to inventory request messages; the disable command NAS message indicates one or more activation criteria for resuming operation of the device, and monitor one or more conditions corresponding to the one or more activation criteria, and in response to determining, based on the monitoring, that at least one activation criterion of the one or more activation criteria is met, resume generation of modulation signals and transmission of responses to inventory request messages; at least one of the first AIoT NAS message and the second AIoT NAS message is an unprotected AIoT NAS message encapsulated in a security protected AIoT NAS message, and the security protected AIoT NAS message includes, in one or more IEs, the security header type, and the message authentication code; the security header includes, in one or more IEs, at least one of an indication of a security status of a corresponding AIoT NAS message, the message authentication code, or a sequence number; the security header type is carried in an initial octet of a corresponding AIoT NAS message and indicates a security status of the corresponding AIoT NAS message; verify integrity of the first AIoT NAS message using the message authentication code; transmit an AIoT inventory report NAS message that includes at least one of the security header, an AIoT device identity of the device, a random challenge, or an authentication response parameter; the AIoT inventory report NAS message is a dedicated authentication procedure response NAS message, and the random challenge and the authentication response parameter are carried in an authentication response IE.

The processor 2800 may support wireless communication in accordance with examples as disclosed herein. The processor 2800 may be configured to or operable to support at least one controller (e.g., the controller 2802) coupled with at least one memory (e.g., the memory 2804) and configured to cause the processor to transmit, to an AIoT device, a first AIoT NAS message that includes a security header type, a message authentication code, and a message type; and receive, from the AIoT device in response to the first AIoT NAS message, a second AIoT NAS message that includes the security header type, the message authentication code, and the message type.

Additionally, the processor 2800 may be configured to or operable to support any one or combination of the first AIoT NAS message is a read command NAS message that includes a memory pointer IE that indicates a start address within a memory of the AIoT device and a data size IE that indicates a first quantity of octets of data to be retrieved from the memory, and initiate a read operation timer in response to transmitting the first AIoT NAS message, and stop the read operation timer in response to receiving the second AIoT NAS message; the second AIoT NAS message indicates a failure cause based on a failure result of a read operation; the second AIoT NAS message is a read complete NAS message that includes an AIoT data IE with an AIoT data length equal to a second quantity of octets, the second quantity of octets is less than the first quantity of octets indicated by the data size IE, and transmit a subsequent read command NAS message that indicates, based on the second quantity of octets, an updated memory pointer IE and an updated data size IE, and receive a subsequent AIoT NAS message that indicates a result of a subsequent read operation; the first AIoT NAS message is a write command NAS message that includes a memory pointer IE that indicates a start address within a memory of the AIoT device and an AIoT data IE that indicates data to be stored in the memory, and initiate a write operation timer in response to transmitting the first AIoT NAS message, and stop the write operation timer in response to receiving the second AIoT NAS message; the second AIoT NAS message indicates a failure cause based on a failure result of a write operation; the second AIoT NAS message is a write complete NAS message that indicates a successful result of a write operation; the AIoT data IE further indicates a first quantity of octets of the data, the second AIoT NAS message is a write complete NAS message that includes a data size IE that indicates a second quantity of octets, the second quantity of octets is less than the first quantity of octets, and transmit a subsequent write command NAS message that indicates, based on the second quantity of octets, an updated memory pointer IE and an updated AIoT data IE, and receive a subsequent AIoT NAS message that indicates a result of a subsequent write operation; the first AIoT NAS message is a disable command NAS message to disable operation of the AIoT device, the second AIoT NAS message is a disable complete NAS message, and initiate a disable operation timer in response to transmitting the first AIoT NAS message, and stop the disable operation timer in response to receiving the second AIoT NAS message; the disable command NAS message indicates one or more activation criteria for resuming operation of the AIoT device; at least one of the first AIoT NAS message and the second AIoT NAS message is an unprotected AIoT NAS message encapsulated in a security protected AIoT NAS message, and the security protected AIoT NAS message includes, in one or more IEs, the security header type, and the message authentication code; the security header includes, in one or more IEs, at least one of an indication of a security status of a corresponding AIoT NAS message, the message authentication code, or a sequence number; the security header type is carried in an initial octet of a corresponding AIoT NAS message and indicates a security status of the corresponding AIoT NAS message; verify integrity of the second AIoT NAS message using the message authentication code; receive an AIoT inventory report NAS message that includes at least one of the security header, an AIoT device identity of the device, a random challenge, or an authentication response parameter; the AIoT inventory report NAS message is a dedicated authentication procedure response NAS message, and the random challenge and the authentication response parameter are carried in an authentication response IE.

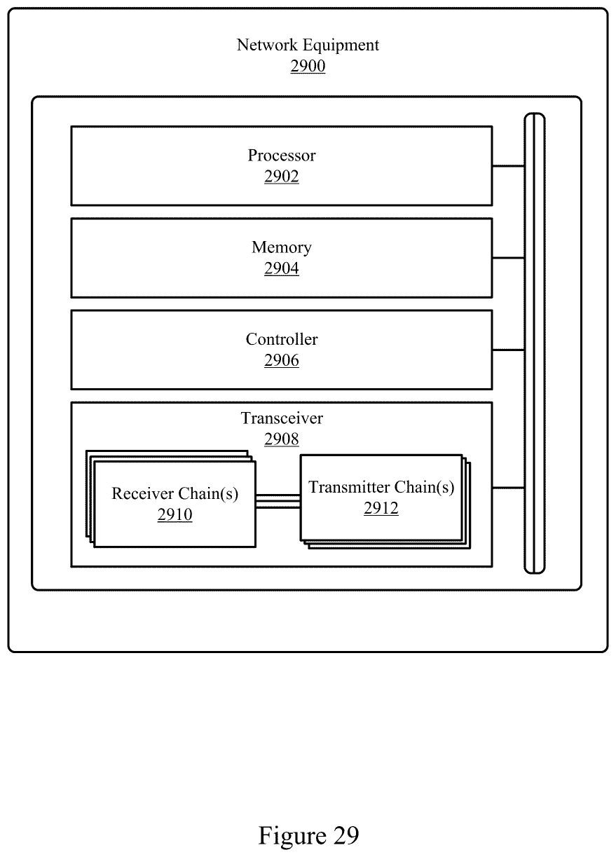

FIG. 29 illustrates an example of an NE 2900 in accordance with aspects of the present disclosure. The NE 2900 may include a processor 2902, a memory 2904, a controller 2906, and a transceiver 2908. The processor 2902, the memory 2904, the controller 2906, or the transceiver 2908, or various combinations thereof or various components thereof may be examples of means for performing various aspects of the present disclosure as described herein. These components may be coupled (e.g., operatively, communicatively, functionally, electronically, electrically) via one or more interfaces.

The processor 2902, the memory 2904, the controller 2906, or the transceiver 2908, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 2902 may include an intelligent hardware device (e.g., a general-purpose processor, a DSP, a CPU, an ASIC, an FPGA, or any combination thereof). In some implementations, the processor 2902 may be configured to operate the memory 2904. In some other implementations, the memory 2904 may be integrated into the processor 2902. The processor 2902 may be configured to execute computer-readable instructions stored in the memory 2904 to cause the NE 2900 to perform various functions of the present disclosure.

The memory 2904 may include volatile or non-volatile memory. The memory 2904 may store computer-readable, computer-executable code including instructions when executed by the processor 2902 cause the NE 2900 to perform various functions described herein. The code may be stored in a non-transitory computer-readable medium such as the memory 2904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 2902 and the memory 2904 coupled with the processor 2902 may be configured to cause the NE 2900 to perform one or more of the functions described herein (e.g., executing, by the processor 2902, instructions stored in the memory 2904). For example, the processor 2902 may support wireless communication at the NE 2900 in accordance with examples as disclosed herein. The NE 2900 may be configured to or operable to support a means for transmitting, to an AIoT device, a first AIoT NAS message that includes a security header type, a message authentication code, and a message type; and receiving, from the AIoT device in response to the first AIoT NAS message, a second AIoT NAS message that includes the security header type, the message authentication code, and the message type.

Additionally, the NE 2900 may be configured to or operable to support any one or combination of the first AIoT NAS message is a read command NAS message that includes a memory pointer IE that indicates a start address within a memory of the AIoT device and a data size IE that indicates a first quantity of octets of data to be retrieved from the memory, and initiating a read operation timer in response to transmitting the first AIoT NAS message; and stopping the read operation timer in response to receiving the second AIoT NAS message; the second AIoT NAS message indicates a failure cause based on a failure result of a read operation; the second AIoT NAS message is a read complete NAS message that includes an AIoT data IE with an AIoT data length equal to a second quantity of octets, the second quantity of octets is less than the first quantity of octets indicated by the data size IE, and transmitting a subsequent read command NAS message that indicates, based on the second quantity of octets, an updated memory pointer IE and an updated data size IE; and receiving a subsequent AIoT NAS message that indicates a result of a subsequent read operation; the first AIoT NAS message is a write command NAS message that includes a memory pointer IE that indicates a start address within a memory of the AIoT device and an AIoT data IE that indicates data to be stored in the memory, and initiating a write operation timer in response to transmitting the first AIoT NAS message; and stopping the write operation timer in response to receiving the second AIoT NAS message; the second AIoT NAS message indicates a failure cause based on a failure result of a write operation; the second AIoT NAS message is a write complete NAS message that indicates a successful result of a write operation; the AIoT data IE further indicates a first quantity of octets of the data, the second AIoT NAS message is a write complete NAS message that includes a data size IE that indicates a second quantity of octets, the second quantity of octets is less than the first quantity of octets, and transmitting a subsequent write command NAS message that indicates, based on the second quantity of octets, an updated memory pointer IE and an updated AIoT data IE; and receiving a subsequent AIoT NAS message that indicates a result of a subsequent write operation; the first AIoT NAS message is a disable command NAS message to disable operation of the AIoT device, the second AIoT NAS message is a disable complete NAS message, and initiating a disable operation timer in response to transmitting the first AIoT NAS message; and stopping the disable operation timer in response to receiving the second AIoT NAS message; the disable command NAS message indicates one or more activation criteria for resuming operation of the AIoT device; at least one of the first AIoT NAS message and the second AIoT NAS message is an unprotected AIoT NAS message encapsulated in a security protected AIoT NAS message, and the security protected AIoT NAS message includes, in one or more IEs, the security header type, and the message authentication code; the security header includes, in one or more IEs, at least one of an indication of a security status of a corresponding AIoT NAS message, the message authentication code, or a sequence number; the security header type is carried in an initial octet of a corresponding AIoT NAS message and indicates a security status of the corresponding AIoT NAS message; verifying integrity of the second AIoT NAS message using the message authentication code; receiving an AIoT inventory report NAS message that includes at least one of the security header, an AIoT device identity of the device, a random challenge, or an authentication response parameter; the AIoT inventory report NAS message is a dedicated authentication procedure response NAS message, and the random challenge and the authentication response parameter are carried in an authentication response IE.

Additionally, or alternatively, the NE 2900 may support at least one memory (e.g., the memory 2904) and at least one processor (e.g., the processor 2902) coupled with the at least one memory and configured to cause the NE to transmit, to an AIoT device, a first AIoT NAS message that includes a security header type, a message authentication code, and a message type; and receive, from the AIoT device in response to the first AIoT NAS message, a second AIoT NAS message that includes the security header type, the message authentication code, and the message type.

Additionally, the NE 2900 may be configured to support any one or combination of the first AIoT NAS message is a read command NAS message that includes a memory pointer IE that indicates a start address within a memory of the AIoT device and a data size IE that indicates a first quantity of octets of data to be retrieved from the memory, and initiate a read operation timer in response to transmitting the first AIoT NAS message, and stop the read operation timer in response to receiving the second AIoT NAS message; the second AIoT NAS message indicates a failure cause based on a failure result of a read operation; the second AIoT NAS message is a read complete NAS message that includes an AIoT data IE with an AIoT data length equal to a second quantity of octets, the second quantity of octets is less than the first quantity of octets indicated by the data size IE, and transmit a subsequent read command NAS message that indicates, based on the second quantity of octets, an updated memory pointer IE and an updated data size IE; and receive a subsequent AIoT NAS message that indicates a result of a subsequent read operation; the first AIoT NAS message is a write command NAS message that includes a memory pointer IE that indicates a start address within a memory of the AIoT device and an AIoT data IE that indicates data to be stored in the memory, and initiate a write operation timer in response to transmitting the first AIoT NAS message, and stop the write operation timer in response to receiving the second AIoT NAS message; the second AIoT NAS message indicates a failure cause based on a failure result of a write operation; the second AIoT NAS message is a write complete NAS message that indicates a successful result of a write operation; the AIoT data IE further indicates a first quantity of octets of the data, the second AIoT NAS message is a write complete NAS message that includes a data size IE that indicates a second quantity of octets, the second quantity of octets is less than the first quantity of octets, and transmit a subsequent write command NAS message that indicates, based on the second quantity of octets, an updated memory pointer IE and an updated AIoT data IE; and receive a subsequent AIoT NAS message that indicates a result of a subsequent write operation; the first AIoT NAS message is a disable command NAS message to disable operation of the AIoT device, the second AIoT NAS message is a disable complete NAS message, and initiate a disable operation timer in response to transmitting the first AIoT NAS message, and stop the disable operation timer in response to receiving the second AIoT NAS message; the disable command NAS message indicates one or more activation criteria for resuming operation of the AIoT device; at least one of the first AIoT NAS message and the second AIoT NAS message is an unprotected AIoT NAS message encapsulated in a security protected AIoT NAS message, and the security protected AIoT NAS message includes, in one or more IEs, the security header type, and the message authentication code; the security header includes, in one or more IEs, at least one of an indication of a security status of a corresponding AIoT NAS message, the message authentication code, or a sequence number; the security header type is carried in an initial octet of a corresponding AIoT NAS message and indicates a security status of the corresponding AIoT NAS message; verify integrity of the second AIoT NAS message using the message authentication code; receive an AIoT inventory report NAS message that includes at least one of the security header, an AIoT device identity of the device, a random challenge, or an authentication response parameter; the AIoT inventory report NAS message is a dedicated authentication procedure response NAS message, and the random challenge and the authentication response parameter are carried in an authentication response IE.

The controller 2906 may manage input and output signals for the NE 2900. The controller 2906 may also manage peripherals not integrated into the NE 2900. In some implementations, the controller 2906 may utilize an operating system such as iOS®, ANDROID®, WINDOWS®, or other operating systems. In some implementations, the controller 2906 may be implemented as part of the processor 2902.

In some implementations, the NE 2900 may include at least one transceiver 2908. In some other implementations, the NE 2900 may have more than one transceiver 2908. The transceiver 2908 may represent a wireless transceiver. The transceiver 2908 may include one or more receiver chains 2910, one or more transmitter chains 2912, or a combination thereof.

A receiver chain 2910 may be configured to receive signals (e.g., control information, data, packets) over a wireless medium. For example, the receiver chain 2910 may include one or more antennas to receive a signal over the air or wireless medium. The receiver chain 2910 may include at least one amplifier (e.g., an LNA) configured to amplify the received signal. The receiver chain 2910 may include at least one demodulator configured to demodulate the receive signal and obtain the transmitted data by reversing the modulation technique applied during transmission of the signal. The receiver chain 2910 may include at least one decoder for decoding the demodulated signal to receive the transmitted data.

A transmitter chain 2912 may be configured to generate and transmit signals (e.g., control information, data, packets). The transmitter chain 2912 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 2912 may also include at least one power amplifier configured to amplify the modulated signal to an appropriate power level suitable for transmission over the wireless medium. The transmitter chain 2912 may also include one or more antennas for transmitting the amplified signal into the air or wireless medium.

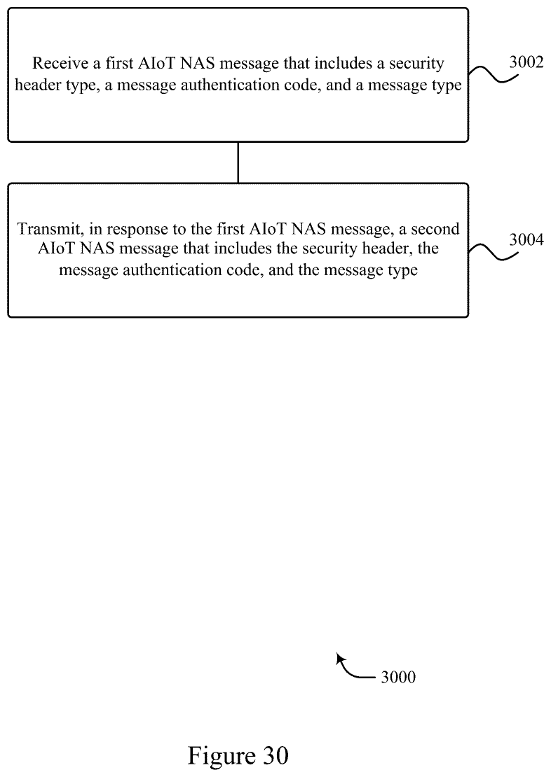

FIG. 30 illustrates a flowchart of a method 3000 in accordance with aspects of the present disclosure. The operations of the method may be implemented by a device as described herein. In some implementations, the device may execute a set of instructions to control the function elements of the device to perform the described functions. It should be noted that the method described herein describes a possible implementation, and that the operations and the steps may be rearranged or otherwise modified and that other implementations are possible.

At 3002, the method may include receiving a first AIoT NAS message that includes a security header, a message authentication code, and a message type. The operations of 3002 may be performed in accordance with examples as described herein. In some implementations, aspects of the operations of 3002 may be performed by a device as described with reference to FIG. 27.

At 3004, the method may include transmitting, in response to the first AIoT NAS message, a second AIoT NAS message that includes the security header, the message authentication code, and the message type. The operations of 3004 may be performed in accordance with examples as described herein. In some implementations, aspects of the operations of 3004 may be performed by a device as described with reference to FIG. 27.

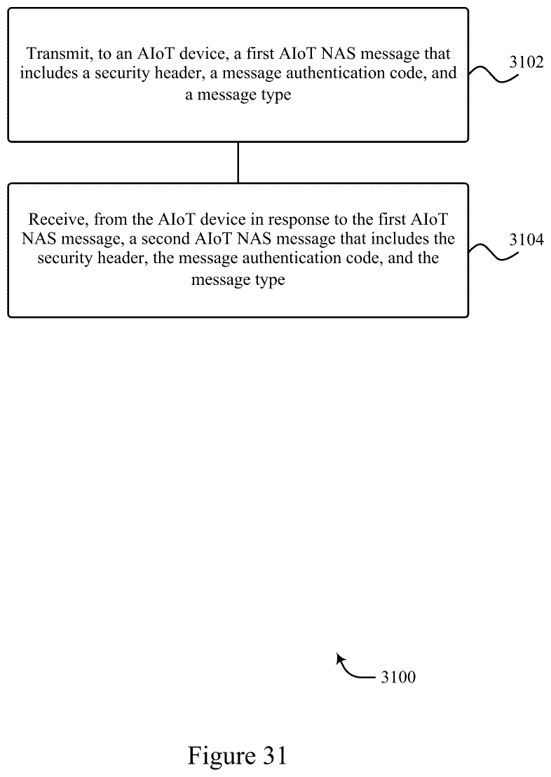

FIG. 31 illustrates a flowchart of a method 3100 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 3102, the method may include transmitting, to an AIoT device, a first AIoT NAS message that includes a security header type, a message authentication code, and a message type. The operations of 3102 may be performed in accordance with examples as described herein. In some implementations, aspects of the operations of 3102 may be performed by an NE as described with reference to FIG. 29.

At 3104, the method may include receiving, from the AIoT device in response to the first AIoT NAS message, a second AIoT NAS message that includes the security header type, the message authentication code, and the message type. The operations of 3104 may be performed in accordance with examples as described herein. In some implementations, aspects of the operations of 3104 may be performed by an NE as described with reference to FIG. 29.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A device for wireless communication, comprising:
at least one memory; and
at least one processor coupled with the at least one memory and operable to cause the device to:
receive a first ambient Internet of things (AIoT) non-access stratum (NAS) message that includes a security header type, a message authentication code, and a message type; and
transmit, in response to the first AIoT NAS message, a second AIoT NAS message that includes the security header type, the message authentication code, and the message type.

2. The device of claim 1, wherein the first AIoT NAS message is a read command NAS message that includes a memory pointer information element (IE) that indicates a start address within the at least one memory and a data size IE that indicates a first quantity of octets of data to be retrieved from the at least one memory, and wherein the at least one processor is operable to cause the device to:
initiate, in response to the read command NAS message, a read operation to retrieve the data from the at least one memory according to the memory pointer IE and the data size IE.

3. The device of claim 2, wherein the second AIoT NAS message indicates a failure cause based at least in part on a failure result of the read operation.

4. The device of claim 2, wherein:
the retrieved data comprises a second quantity of octets that is less than the first quantity of octets indicated by the data size IE, and
the second AIoT NAS message is a read complete NAS message that includes an AIoT data IE with an AIoT data length equal to the second quantity of octets.

5. The device of claim 4, wherein the at least one processor is further operable to cause the device to:
receive a subsequent read command NAS message that indicates, based at least in part on the second quantity of octets, an updated memory pointer IE and an updated data size IE;
initiate a subsequent read operation according to the updated memory pointer IE and the updated data size IE; and
transmit a subsequent AIoT NAS message that indicates a result of the subsequent read operation.

6. The device of claim 1, wherein the first AIoT NAS message is a write command NAS message that includes a memory pointer information element (IE) that indicates a start address within the at least one memory and an AIoT data IE that indicates data to be stored in the at least one memory, and wherein the at least one processor is operable to cause the device to:
initiate, in response to the first AIoT NAS message, a write operation to store the data in the at least one memory according to the memory pointer IE and the AIoT data IE.

7. The device of claim 6, wherein the second AIoT NAS message indicates a failure cause based at least in part on a failure result of the write operation.

8. The device of claim 6, wherein the second AIoT NAS message is a write complete NAS message that indicates a successful result of the write operation.

9. The device of claim 6, wherein:
the AIoT data IE further indicates a first quantity of octets of the data,
the stored data comprises a second quantity of octets that is less than the first quantity of octets indicated by the AIoT data IE, and
the second AIoT NAS message is a write complete NAS message that includes a data size IE that indicates the second quantity of octets.

10. The device of claim 9, wherein the at least one processor is further operable to cause the device to:
receive a subsequent write command NAS message that indicates, based at least in part on the second quantity of octets, an updated memory pointer IE and an updated AIoT data IE;
initiate a subsequent write operation according to the updated memory pointer IE and the updated AIoT data IE; and
transmit a subsequent AIoT NAS message that indicates a result of the subsequent write operation.

11. The device of claim 1, wherein:
the first AIoT NAS message is a disable command NAS message,
the second AIoT NAS message is a disable complete NAS message, and
the at least one processor is operable to cause the device to:
disable, subsequent to transmitting the disable complete NAS message, generation of modulation signals; and
disable, subsequent to transmitting the disable complete NAS message, transmission of responses to inventory request messages.

12. The device of claim 11, wherein the disable command NAS message indicates one or more activation criteria for resuming operation of the device, and wherein the at least one processor is further operable to cause the device to:
monitor one or more conditions corresponding to the one or more activation criteria; and
in response to determining, based at least in part on the monitoring, that at least one activation criterion of the one or more activation criteria is met, resume generation of modulation signals and transmission of responses to inventory request messages.

13. A network entity (NE) for wireless communication, comprising:
at least one memory; and
at least one processor coupled with the at least one memory and operable to cause the NE to:
transmit, to an ambient internet of things (AIoT) device, a first AIoT non-access stratum (NAS) message that includes a security header type, a message authentication code, and a message type; and
receive, from the AIoT device in response to the first AIoT NAS message, a second AIoT NAS message that includes the security header type, the message authentication code, and the message type.

14. The NE of claim 13, wherein the first AIoT NAS message is a read command NAS message that includes a memory pointer information element (IE) that indicates a start address within a memory of the AIoT device and a data size IE that indicates a first quantity of octets of data to be retrieved from the memory, and wherein the at least one processor is operable to cause the NE to:
initiate a read operation timer in response to transmitting the first AIoT NAS message; and
stop the read operation timer in response to receiving the second AIoT NAS message.

15. The NE of claim 14, wherein:
the second AIoT NAS message is a read complete NAS message that includes an AIoT data IE with an AIoT data length equal to a second quantity of octets,
the second quantity of octets is less than the first quantity of octets indicated by the data size IE, and
the at least one processor is further operable to cause the NE to:
transmit a subsequent read command NAS message that indicates, based at least in part on the second quantity of octets, an updated memory pointer IE and an updated data size IE; and
receive a subsequent AIoT NAS message that indicates a result of a subsequent read operation.

16. The NE of claim 13, wherein the first AIoT NAS message is a write command NAS message that includes a memory pointer information element (IE) that indicates a start address within a memory of the AIoT device and an AIoT data IE that indicates data to be stored in the memory, and wherein the at least one processor is operable to cause the NE to:
initiate a write operation timer in response to transmitting the first AIoT NAS message; and
stop the write operation timer in response to receiving the second AIoT NAS message.

17. The NE of claim 16, wherein:
the AIoT data IE further indicates a first quantity of octets of the data,
the second AIoT NAS message is a write complete NAS message that includes a data size IE that indicates a second quantity of octets,
the second quantity of octets is less than the first quantity of octets, and
the at least one processor is further operable to cause the NE to:
transmit a subsequent write command NAS message that indicates, based at least in part on the second quantity of octets, an updated memory pointer IE and an updated AIoT data IE; and
receive a subsequent AIoT NAS message that indicates a result of a subsequent write operation.

18. The NE of claim 13, wherein:
the first AIoT NAS message is a disable command NAS message to disable operation of the AIoT device,
the second AIoT NAS message is a disable complete NAS message, and
the at least one processor is further operable to cause the NE to:
initiate a disable operation timer in response to transmitting the first AIoT NAS message; and
stop the disable operation timer in response to receiving the second AIoT NAS message.

19. A method performed by a device, the method comprising:
receiving a first ambient Internet of things (AIoT) non-access stratum (NAS) message that includes a security header type, a message authentication code, and a message type; and
transmitting, in response to the first AIoT NAS message, a second AIoT NAS message that includes the security header type, the message authentication code, and the message type.

20. A method performed by a network entity (NE), the method comprising:
transmitting, to an ambient internet of things (AIoT) device, a first AIoT non-access stratum (NAS) message that includes a security header type, a message authentication code, and a message type; and
receiving, from the AIoT device in response to the first AIoT NAS message, a second AIoT NAS message that includes the security header type, the message authentication code, and the message type.
